(19) United States
(12) Patent Application Publication
(10) Pub. No.: US 2024/0412254 A1
(43) Pub. Date: Dec. 12, 2024

(54) SYSTEMS AND METHODS FOR GENERATING OFFERS, CAMPAIGNS, AND RULES FOR INTEGRATION WITH WEBSITES

(71) Applicant: RevLifter Ltd., London (GB)

(72) Inventors: Simon Bird, Northamptonshire (GB); Ian Compton, London (GB); Adam Gordon Manners, Waltham Cross (GB); Matt Payne, Northamptonshire (GB)

(73) Assignee: RevLifter Ltd., London, GB (GB)

(21) Appl. No.: 18/480,439

(22) Filed: Oct. 3, 2023

Related U.S. Application Data
(60) Provisional application No. 63/472,219, filed on Jun. 9, 2023.
(60) Provisional application No. 63/472,200, filed on Jun. 9, 2023.

(51) Int. Cl. G06Q 30/0251; G06Q 30/0241; G06Q 30/0242

(52) U.S. Cl. CPC G06Q 30/0258; G06Q 30/0246; G06Q 30/0277

(57) ABSTRACT

An offer and campaign management system for generating offers, campaigns, and rules for integration with a website. The offer and campaign management system provides user interfaces that allow users to create offers, campaigns, and rules. The user interfaces allow the user to define offers for website products. The user interfaces allow the user to define campaigns, by which offers are provided to website users, and link offers with campaigns. The user interfaces allow the user to define rules and link rules with offers. A rule includes one or more criteria that must be satisfied in order for the offer and campaign management system to show an offer linked with the rule. The offer and campaign management system integrates the offers, campaigns, and rules with the website in such a way that the offers, campaigns, and rules may appear to website users to be provided by the website itself.

### CROSS-REFERENCE TO RELATED APPLICATIONS

This application claims priority to U.S. Provisional Patent Application No. 63/472,219, filed on Jun. 9, 2023, and entitled “SYSTEMS AND METHODS FOR GENERATING OFFERS, CAMPAIGNS, AND RULES FOR INTEGRATION WITH WEBSITES”, and to U.S. Provisional Patent Application No. 63/472,200, filed on Jun. 9, 2023, and entitled “SYSTEMS AND METHODS FOR PROVIDING WEBPAGES CONTAINING PERSONALIZED OFFERS AND INFORMATION”, and is related to U.S. patent application Ser. No. 18/307,363, filed on Apr. 26, 2023 and entitled “SYSTEMS AND METHODS FOR PROVIDING PERSONALIZED OFFERS AND INFORMATION,” and to U.S. patent application Ser. No. 18/470,178, filed on Sep. 19, 2023, and entitled “SYSTEMS AND METHODS FOR PROVIDING PERSONALIZED OFFERS AND INFORMATION IN WEBPAGES,” each of which is incorporated in its entirety herein by reference.

### FIELD OF THE INVENTION(S)

Embodiments of the present invention(s) are generally related to generating offers, campaigns, and rules for integration with websites, and in particular to providing user interfaces that allow users to generate offers, campaigns, and rules for integration with websites.

### BACKGROUND

A website that provides products for sale may provide offers to entice users to purchase a product. The website may display such offers only on certain pages of the website, such as on a landing page or home page, and not on other pages of the website. In order to display such offers on the website, a website administrator may have to include the offer in the HTML or JavaScript code of the certain pages. This may have several disadvantages, such as requiring the website administrator to manually edit HTML or JavaScript code, and may not be scalable.

The entity that operates the website may wish to provide the same offer at different points in the year or in response to different events or conditions. However, the entity may have to include the offer in the website code at the different points in the year, which may take time and resources to implement. Moreover, the entity may not be able to change the website code in time for certain events that occur quickly and without much notice.

Furthermore, the entity may wish to provide different offers to different website users based on the behavior, attributes, and/or characteristics of the website users. However, the website may not have any way of detecting such behavior, attributes, and/or characteristics of the website users, and thus not be able to provide different offers to different website users.

### SUMMARY

In some aspects, the techniques described herein relate to a non-transitory computer-readable medium including executable instructions, the executable instructions being executable by one or more processors to perform a method, the method including: providing an offer user interface of an offer and campaign management system, the offer user interface configured to allow a user to provide offer attributes for an offer, a visual representation of which may be displayed on a website that offers products for sale to users of the website, the offer attributes including an offer title, an offer discount code, and an offer tag, the offer and campaign management system of a first entity, the website of a second entity distinct from the first entity; receiving, via the offer user interface, first offer attributes for a first offer, the first offer attributes including a first offer title, a first offer discount code, and a first offer tag; generating the first offer based on the first offer attributes; receiving, via the offer user interface, second offer attributes for a second offer, the second offer attributes including a second offer title, a second offer discount code, and the first offer tag; generating the second offer based on the second offer attributes; providing a campaign user interface of the offer and campaign management system, the campaign user interface configured to allow the user to provide campaign attributes for a campaign by which visual representations of offers may be displayed on the website, the campaign attributes including a campaign title, an offer tag for linking the campaign to one or more offers, and one or more campaign activation criteria for activating the campaign, the one or more campaign activation criteria for activating the campaign including at least one of page access criteria, user interaction criteria, and user agent criteria; receiving, via the campaign user interface, first campaign attributes for a first campaign, the first campaign attributes including a first campaign title, the first offer tag, and one or more first campaign activation criteria for activating the first campaign; generating the first campaign based on the first campaign attributes; linking the first offer and the second offer with the first campaign based on the first offer tag; detecting at least one of a first page access by a first user, first user interactions with the website by the first user, and a first user agent of the first user; determining that at least one of the first page access by the first user, the first user interactions with the website by the first user, and the first user agent of the first user satisfy the one or more first campaign activation criteria for activating the first campaign; activating the first campaign; selecting the first offer or the second offer; and displaying a first visual representation of the first offer including the first offer title and the first offer discount code or a second visual representation of the second offer including the second offer title and the second offer discount code on the website.

In some aspects, the techniques described herein relate to a non-transitory computer-readable medium, the method further including: providing a rule user interface of the offer and campaign management system, the rule user interface configured to allow the user to provide rule attributes for a rule which may be linked to one or more offers, the rule attributes including a rule name and one or more rule conditions; receiving, via the rule user interface, first rule attributes for a first rule that may be applied to one or more offers, the first rule attributes including a first rule name and one or more first rule conditions; generating the first rule based on the first rule attributes; receiving a request to link the first offer with the first rule; linking the first offer with the first rule; receiving, via the rule user interface, second rule attributes for a second rule that may be applied to one or more offers, the second rule attributes including a second rule name and one or more second rule conditions; generating the second rule based on the second rule attributes; receiving a request to link the second offer and the second rule; and linking the second offer and the second rule; wherein selecting the first offer or the second offer includes selecting the first offer based on the one or more first rule conditions of the first rule or selecting the second offer based on the one or more second rule conditions of the second rule.

In some aspects, the techniques described herein relate to a non-transitory computer-readable medium wherein the one or more first rule conditions specify a first range of amounts of one or more products selected for purchase on the website and the one or more second rule conditions specify a second range of amounts of one or more products selected for purchase on the website, the second range of amounts of one or more products being greater than the first range of amounts of one or more products.

In some aspects, the techniques described herein relate to a non-transitory computer-readable medium, the method further including detecting an amount of one or more products selected for purchase on the website by the first user, wherein selecting the first offer or the second offer includes selecting the first offer if the amount of one or more products selected for purchase on the website by the first user falls within the first range of amounts of one or more products and selecting the second offer if the amount of one or more products selected for purchase on the website by the first user falls within the second range of amounts of one or more products.

In some aspects, the techniques described herein relate to a non-transitory computer-readable medium, the method further including: detecting second user interactions with the website by the first user; and updating a first user profile of the first user to include the second user interactions with the website by the first user; wherein selecting the first offer or the second offer includes selecting the first offer based on the one or more first rule conditions of the first rule and the first user profile of the first user or selecting the second offer based on the one or more second rule conditions of the second rule and the first user profile of the first user.

In some aspects, the techniques described herein relate to a non-transitory computer-readable medium, the method further including: receiving a request to calculate an estimated reach of the first rule; evaluating the first rule against user profiles of users who have accessed the website; calculating the estimated reach of the first rule based on evaluating the first rule against the user profiles of the users who have accessed the website, and displaying a visual indication of the estimated reach of the first rule.

In some aspects, the techniques described herein relate to a non-transitory computer-readable medium, the method further including publishing the first campaign.

In some aspects, the techniques described herein relate to a non-transitory computer-readable medium wherein publishing the first campaign includes generating executable instructions for execution by computing devices of users who access the website, the executable instructions including the one or more first campaign activation criteria for activating the first campaign, and wherein: detecting at least one of the first page access by the first user, the first user interactions with the website by the first user, and the first user agent of the first user includes detecting, using the executable instructions, at least one of the first page access by the first user, the first user interactions with the website by the first user, and the first user agent of the first user, determining that at least one of the first page access by the first user, the first user interactions with the website by the first user, and the first user agent of the first user satisfy the one or more first campaign activation criteria for activating the first campaign includes determining, using the executable instructions, that at least one of the first page access by the first user, the first user interactions with the website by the first user, and the first user agent of the first user satisfy the one or more first campaign activation criteria for activating the first campaign, and activating the first campaign includes activating, using the executable instructions, the first campaign.

In some aspects, the techniques described herein relate to a non-transitory computer-readable medium wherein the campaign user interface is further configured to allow the user to select a preview mode for a campaign, the method further including: receiving a selection of the preview mode for the first campaign; placing the first campaign in the preview mode; and receiving a request to preview the first campaign, wherein activating the first campaign includes activating the first campaign in response to receiving the request to preview the first campaign.

In some aspects, the techniques described herein relate to a non-transitory computer-readable medium, the method further including: receiving, via the offer user interface, third offer attributes for a third offer that may be displayed on the website, the third offer attributes including a third offer title, a third offer discount code, and a second offer tag, the second offer tag being different from the first offer tag; generating the third offer based on the third offer attributes; receiving, via the campaign user interface, second campaign attributes for a second campaign, the second campaign attributes including a second campaign title, the second offer tag, and one or more second campaign activation criteria for activating the second campaign; generating the second campaign based on the second campaign attributes; and linking the third offer with the second campaign based on the second offer tag.

In some aspects, the techniques described herein relate to a method including: providing an offer user interface of an offer and campaign management system, the offer user interface configured to allow a user to provide offer attributes for an offer, a visual representation of which may be displayed on a website that offers products for sale to users of the website, the offer attributes including an offer title, an offer discount code, and an offer tag, the offer and campaign management system of a first entity, the website of a second entity distinct from the first entity; receiving, via the offer user interface, first offer attributes for a first offer, the first offer attributes including a first offer title, a first offer discount code, and a first offer tag; generating the first offer based on the first offer attributes; receiving, via the offer user interface, second offer attributes for a second offer, the second offer attributes including a second offer title, a second offer discount code, and the first offer tag; generating the second offer based on the second offer attributes; providing a campaign user interface of the offer and campaign management system, the campaign user interface configured to allow the user to provide campaign attributes for a campaign by which visual representations of offers may be displayed on the website, the campaign attributes including a campaign title, an offer tag for linking the campaign to one or more offers, and one or more campaign activation criteria for activating the campaign, the one or more campaign activation criteria for activating the campaign including at least one of page access criteria, user interaction criteria, and user agent criteria; receiving, via the campaign user interface, first campaign attributes for a first campaign, the first campaign attributes including a first campaign title, the first offer tag, and one or more first campaign activation criteria for activating the first campaign; generating the first campaign based on the first campaign attributes; linking the first offer and the second offer with the first campaign based on the first offer tag; detecting at least one of a first page access by a first user, first user interactions with the website by the first user, and a first user agent of the first user; determining that at least one of the first page access by the first user, the first user interactions with the website by the first user, and the first user agent of the first user satisfy the one or more first campaign activation criteria for activating the first campaign; activating the first campaign; selecting the first offer or the second offer; and displaying a first visual representation of the first offer including the first offer title and the first offer discount code or a second visual representation of the second offer including the second offer title and the second offer discount code on the website.

In some aspects, the techniques described herein relate to a method, further including: providing a rule user interface of the offer and campaign management system, the rule user interface configured to allow the user to provide rule attributes for a rule which may be linked to one or more offers, the rule attributes including a rule name and one or more rule conditions; receiving, via the rule user interface, first rule attributes for a first rule that may be applied to one or more offers, the first rule attributes including a first rule name and one or more first rule conditions; generating the first rule based on the first rule attributes; receiving a request to link the first offer with the first rule; linking the first offer with the first rule; receiving, via the rule user interface, second rule attributes for a second rule that may be applied to one or more offers, the second rule attributes including a second rule name and one or more second rule conditions; generating the second rule based on the second rule attributes; receiving a request to link the second offer and the second rule; and linking the second offer and the second rule; wherein selecting the first offer or the second offer includes selecting the first offer based on the one or more first rule conditions of the first rule or selecting the second offer based on the one or more second rule conditions of the second rule.

In some aspects, the techniques described herein relate to a method wherein the one or more first rule conditions specify a first range of amounts of one or more products selected for purchase on the website and the one or more second rule conditions specify a second range of amounts of one or more products selected for purchase on the website, the second range of amounts of one or more products being greater than the first range of amounts of one or more products.

In some aspects, the techniques described herein relate to a method, further including detecting an amount of one or more products selected for purchase on the website by the first user, wherein selecting the first offer or the second offer includes selecting the first offer if the amount of one or more products selected for purchase on the website by the first user falls within the first range of amounts of one or more products and selecting the second offer if the amount of one or more products selected for purchase on the website by the first user falls within the second range of amounts of one or more products.

In some aspects, the techniques described herein relate to a method, further including: detecting second user interactions with the website by the first user; and updating a first user profile of the first user to include the second user interactions with the website by the first user; wherein selecting the first offer or the second offer includes selecting the first offer based on the one or more first rule conditions of the first rule and the first user profile of the first user or selecting the second offer based on the one or more second rule conditions of the second rule and the first user profile of the first user.

In some aspects, the techniques described herein relate to a method, further including: receiving a request to calculate an estimated reach of the first rule; evaluating the first rule against user profiles of users who have accessed the website; and calculating the estimated reach of the first rule based on evaluating the first rule against the user profiles of the users who have accessed the website.

In some aspects, the techniques described herein relate to a method, further including publishing the first campaign.

In some aspects, the techniques described herein relate to a method wherein publishing the first campaign includes generating executable instructions for execution by computing devices of users who access the website, the executable instructions including the one or more first campaign activation criteria for activating the first campaign, and wherein: detecting at least one of the first page access by the first user, the first user interactions with the website by the first user, and the first user agent of the first user includes detecting, using the executable instructions, at least one of the first page access by the first user, the first user interactions with the website by the first user, and the first user agent of the first user, determining that at least one of the first page access by the first user, the first user interactions with the website by the first user, and the first user agent of the first user satisfy the one or more first campaign activation criteria for activating the first campaign includes determining, using the executable instructions, that at least one of the first page access by the first user, the first user interactions with the website by the first user, and the first user agent of the first user satisfy the one or more first campaign activation criteria for activating the first campaign, and activating the first campaign includes activating, using the executable instructions, the first campaign.

In some aspects, the techniques described herein relate to a method wherein the campaign user interface is further configured to allow the user to select a preview mode for a campaign, and the method further includes: receiving a selection of the preview mode for the first campaign; placing the first campaign in the preview mode; and receiving a request to preview the first campaign, wherein activating the first campaign includes activating the first campaign in response to receiving the request to preview the first campaign.

In some aspects, the techniques described herein relate to a system including at least one processor and memory containing instructions, the instructions being executable by the at least one processor to: provide an offer user interface of an offer and campaign management system, the offer user interface configured to allow a user to provide offer attributes for an offer, a visual representation of which may be displayed on a website that offers products for sale to users of the website, the offer attributes including an offer title, an offer discount code, and an offer tag, the offer and campaign management system of a first entity, the website of a second entity distinct from the first entity; receive, via the offer user interface, first offer attributes for a first offer, the first offer attributes including a first offer title, a first offer discount code, and a first offer tag; generate the first offer based on the first offer attributes; receive, via the offer user interface, second offer attributes for a second offer, the second offer attributes including a second offer title, a second offer discount code, and the first offer tag; generate the second offer based on the second offer attributes; provide a campaign user interface of the offer and campaign management system, the campaign user interface configured to allow the user to provide campaign attributes for a campaign by which visual representations of offers may be displayed on the website, the campaign attributes including a campaign title, an offer tag for linking the campaign to one or more offers, and one or more campaign activation criteria for activating the campaign, the one or more campaign activation criteria for activating the campaign including at least one of page access criteria, user interaction criteria, and user agent criteria; receive, via the campaign user interface, first campaign attributes for a first campaign, the first campaign attributes including a first campaign title, the first offer tag, and one or more first campaign activation criteria for activating the first campaign; generate the first campaign based on the first campaign attributes; link the first offer and the second offer with the first campaign based on the first offer tag; detect at least one of a first page access by a first user, first user interactions with the website by the first user, and a first user agent of the first user; determine that at least one of the first page access by the first user, the first user interactions with the website by the first user, and the first user agent of the first user satisfy the one or more first campaign activation criteria for activating the first campaign; activate the first campaign; select the first offer or the second offer; and display a first visual representation of the first offer including the first offer title and the first offer discount code or a second visual representation of the second offer including the second offer title and the second offer discount code on the website.

### BRIEF DESCRIPTION OF THE DRAWINGS

FIG. 1 is a block diagram depicting an example environment in which a personalized offer and campaign management system may operate in some embodiments.

FIG. 2 is a block diagram depicting components of a personalized offer and campaign management system in some embodiments.

FIG. 3 is a flow diagram depicting a method for providing offer user interfaces, campaign user interfaces, and rule user interfaces for receiving offer attributes for offers, campaign attributes for campaigns, and rule attributes for rules, in some embodiments.

FIGS. 4A-4H depict example user interfaces for receiving offer attributes for offers in some embodiments.

FIGS. 5A-5H depict example user interfaces for receiving campaign attributes for campaigns in some embodiments.

FIGS. 6A-6J depict example user interfaces for receiving rules in some embodiments.

FIG. 6K is a block diagram depicting an activation, a campaign, offers, and rules in some embodiments.

FIG. 6L is a block diagram depicting priorities of offers in some embodiments.

FIG. 7A depicts an example user interface for displaying segments in some embodiments.

FIG. 7B depicts an example user interface for receiving segments in some embodiments.

FIGS. 8A and 8B depict example user interfaces for providing campaign performance reports and offer performance reports in some embodiments.

FIGS. 9A-9C depict example user interfaces for receiving mappings of events in some embodiments.

FIG. 10A is a block diagram depicting data flow between certain components of a personalized offer and campaign management system and a website in some embodiments.

FIG. 10B is a flow diagram depicting a method for generating personalized offers and campaigns in some embodiments.

FIGS. 11A-C depict example user interfaces for personalized offers and information in some embodiments.

FIG. 12A depicts an example user interface displaying a visual indication of offers in some embodiments.

FIG. 12B depicts the example user interface of FIG. 12A with a panel in which offers are displayed in some embodiments.

FIG. 13A depicts an example user interface for displaying offers in some embodiments.

FIG. 13B depicts an example user interface for displaying offers in an offer group in some embodiments.

FIG. 14A depicts an example user interface displaying an offer in some embodiments.

FIG. 14B depicts an example user interface with a panel in which the offer of FIG. 14A is displayed in some embodiments.

FIG. 15 is a block diagram depicting an example digital device in some embodiments.

Throughout the drawings, like reference numerals will be understood to refer to like parts, components, and structures.

### DETAILED DESCRIPTION

An entity that operates a website may utilize the offer and campaign management system described herein to generate offers, campaigns, and rules that may be integrated with the website. The offer and campaign management system provides user interfaces that allow a user associated with the entity to quickly and easily create offers, campaigns, and rules. The user interfaces allow the user to define offers for products sold by the website. The user interfaces also allow the user to define campaigns and link offers with campaigns. A campaign is the means by which the offer and campaign management system provides offers to website users. The user interfaces also allow the user to define rules and link rules with offers. A rule includes a group of one or more criteria that must be satisfied in order for the offer and campaign management system to show an offer linked with the rule. The offer and campaign management system integrates the offers, campaigns, and rules with the website in such a way that the offers, campaigns, and rules appear to website users to be provided by the website itself.

The user may create several types of offers for display on the website. One type of offer is a discount code offer that includes a discount code for products sold by the website. Another type of offer is a weblink offer that includes a weblink to a page on the website. Another type of offer is a recommendations offer that includes recommendations for products sold by the website. The user may also create several types of campaigns for integration with the website. One type of campaign is a personalized deals page campaign with offers and/or information that may sit within or outside of a website domain operated by the entity. Another type of campaign is a pop-up campaign that can deliver targeted pop-ups with offers and/or information to website users. Another type of campaign is a wallet campaign that provides a personalized hub for offers and/or information for website users. The user may also define activation criteria for activating the campaign on the website. The offer and campaign management system would not activate a campaign with such activation criteria until the activation criteria are satisfied.

The user may also create rules with conditions or criteria and link the rules with offers. The use of rules allows the offer and campaign management system to personalize offers based on the behavior, attributes, and/or characteristics of the website user. For example, the user may create a rule related to a threshold amount (in currency) the value of items the website user has selected for sale and link the rule with a discount code offer. Once the campaign has been activated, the offer and campaign management system may, in some cases, only show the discount code offer if the offer and campaign management system detects that the website user has selected for purchase items the value of which exceeds the threshold amount.

For certain campaign types, when a website user accesses the website, the offer and campaign management system detects the website user access and determine if the website user access activates the start of a campaign. The offer and campaign management system detects information such as website user interactions with the website, products or services the website user views and/or selects for purchase, user attributes, characteristics, and/or other information. The offer and campaign management system builds a user profile based on the detected information. The campaign may be linked with one or more offers for which the website user may be eligible. If the offer and campaign management system has activated the campaign, the offer and campaign management system determines what offers, if any, to show the website user based on the user profile and the available offers. The offer and campaign management system may also use the user profile to determine personalized contextual information, such as product or category recommendations, to show to the website user. If the website user is eligible for offers, the offer and campaign management system may display the offers to the website user.

For the wallet campaign type, the offer and campaign management system may use a user interface element, such as a launcher, to display a visual indication of the offers to the website user. The offer and campaign management system may do this by updating a launcher counter or by causing the launcher to display text indicating that the website user has offers available. The offer and campaign management system may use a second user interface element, such as a panel, in which the offer and campaign management system displays the offers. The panel may be initially hidden, and users may select the launcher to have the panel become visible. The offer and campaign management system may then display the panel in which the offers are displayed. The website user may close the panel. After the panel has been closed, the offer and campaign management system may continue to display the launcher. This enables the website user to see that the website user still has offers available. The launcher may also persist the personalized offers and information for website users across sessions so that website users may see the personalized offers and information every time the website users return to the website.

An offer may include a countdown timer that indicates for how much longer the offer is available and/or a progress bar that indicates an amount of progress the website user has made towards qualifying for the offer and an amount of progress the website user still has to make to qualify for the offer. For example, the countdown timer may indicate that an offer may expire in a period of 24 hours from the time the website user first viewed the offer. As another example, an offer may provide free shipping or a discount code if the website user purchases or selects for purchase products or services whose value exceeds a threshold amount. The progress bar may indicate to the website user the progress the website user has made and the progress the website user still has to make to qualify for the offer based on the value of the products or services the website user has selected for purchase.

The offer and campaign management system described herein may provide numerous advantages. First, by providing accessible user interfaces, the offer and campaign management system allows users to quickly and easily create offers, campaigns, and rules. Second, the offer and campaign management allows users to link offers with multiple campaigns and different campaign types. This allows users to reuse or repurpose offers across different campaigns at different points in time and across different campaign types. Third, the offer and campaign management allows users to define rules with one or more criteria or conditions and to link rules with offers. This allows users to personalize offers to website users based on the behavior, attributes, and/or characteristics, of the website user, and/or other information that may be relevant to the website user. By personalizing offers to website users, the offer and campaign management system provides offers and information that are likely more relevant and meaningful to the website users.

Fourth, by providing personalized offers and information to website users, the offer and campaign management system may increase the likelihood of the website users purchasing a product or service and may increase engagement of the website users with the website. Accordingly, the conversion rate of the entity operating the website may increase and the brand loyalty of the website user to the entity may also increase. Fifth, by providing countdown timers and progress bars to the website user, the personalized offers and information may encourage or incentivize the website user to take actions to redeem the offer and/or qualify for the offer. Such encouragement may result in the website user purchasing more products or services than the website user would purchase without the encouragement. Accordingly, the offer and campaign management system may increase the average order value (AOV) of the website.

Although many examples herein describe the offer and campaign management system allowing a single user associated with a single entity to create offers, campaigns, and rules for a single website, the offer and campaign management system is scalable to numerous users at a single entity and to numerous entities and numerous websites. In other words, the offer and campaign management system may provide user interfaces for creating offers, campaigns, and rules to any number of users associated with any number of entities and any number of websites. Furthermore, the offer and campaign management system may provide personalized offers and information to any number of website users at any number of websites. The scalability of the personalized offers and information is due, in part, to the architecture of the offer and campaign management system. The architecture of the offer and campaign management system allows the offer and campaign management system to, in real-time or near real-time, detect website user interactions, update user profiles, and provide personalized offers and information to numerous users, all in a low-latency or near low-latency fashion. Accordingly, the offer and campaign management system is scalable to meet the demands of entities to provide personalized offers and information to the website users of the entities' websites.

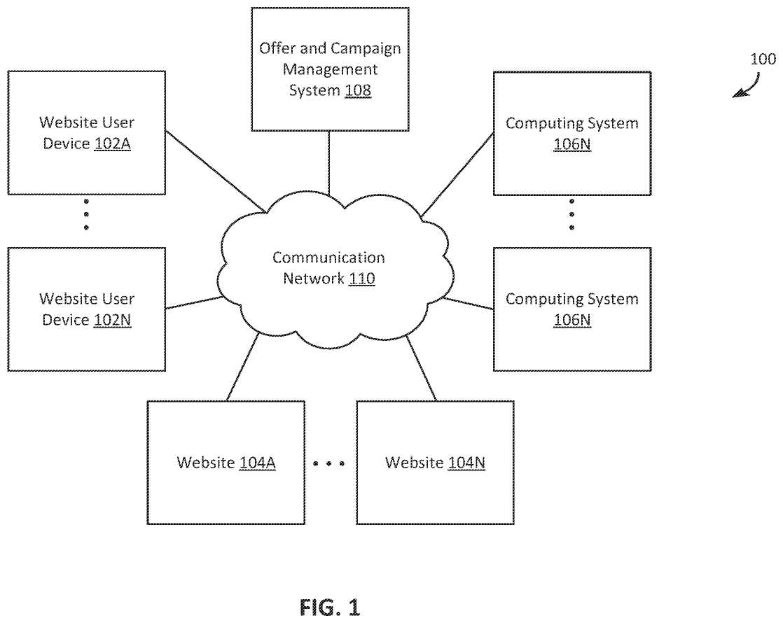

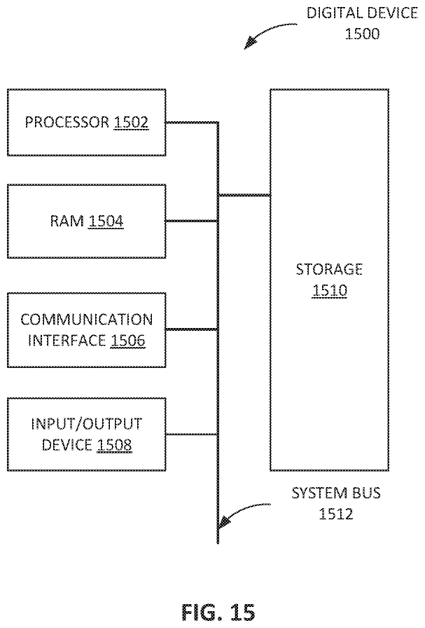

FIG. 1 depicts an example environment 100 in which an offer and campaign management system 108 may operate in some embodiments. The example environment 100 includes multiple website user devices 102A through 102N (referred to as a website user device 102 or as website user devices 102), multiple websites 104A through 104N (referred to as a website 104 or as websites 104), multiple computing systems 106A through 106N (referred to as a computing system 106 or as computing systems 106), the offer and campaign management system 108, and a communication network 110. Each of the website user device 102, the website 104, the computing system 106, and the offer and campaign management system 108 may be or include any number of digital devices. A digital device is any device with at least one processor and memory. Digital devices are discussed further herein, for example, with reference to FIG. 15.

A first entity, such as a person, a retailer, a wholesaler, a distributor, a manufacturer or any other entity, may operate the website 104. The website 104 may provide products, services, or software for sale, lease or license. A website user may use a website user device 102 to access the website 104 in order to view products, services or software, select products, services or software for purchase, lease, or license, and/or purchase, lease, or license products, services or software. A second entity, distinct from the first entity, may operate the offer and campaign management system 108.

Users associated with the first entity may operate the computing system 106 to perform various functions, including configuring the website 104 and sending requests and/or data to and receiving requests and/or data from the offer and campaign management system 108. For example, the first entity may utilize the computing system 106 to define campaigns, offers, and rules that the offer and campaign management system 108 uses to provide personalized offers to the website 104 for display to the user on the website user device 102. The offer and campaign management system 108 may provide user interfaces to users associated with the first entity to allow such users to configure offers for users of the website 104 and to configure campaigns by which such offers may be provided to the users of the website 104. The offer and campaign management system 108 may also provide the offers and the campaigns to the website 104 so that the campaigns may be activated on the website 104 and so that the offers may be displayed to users on the website 104.

In some embodiments, the communication network 110 may represent one or more computer networks (for example, LAN, WAN, and/or the like). The communication network 110 may provide communication between any of the website user device 102, the website 104, the computing system 106, and the offer and campaign management system 108. In some implementations, the communication network 110 comprises computer devices, routers, cables, and/or other network topologies. In some embodiments, the communication network 110 may be wired and/or wireless. In various embodiments, the communication network 110 may comprise the Internet, one or more networks that may be public, private, IP-based, non-IP based, and so forth.

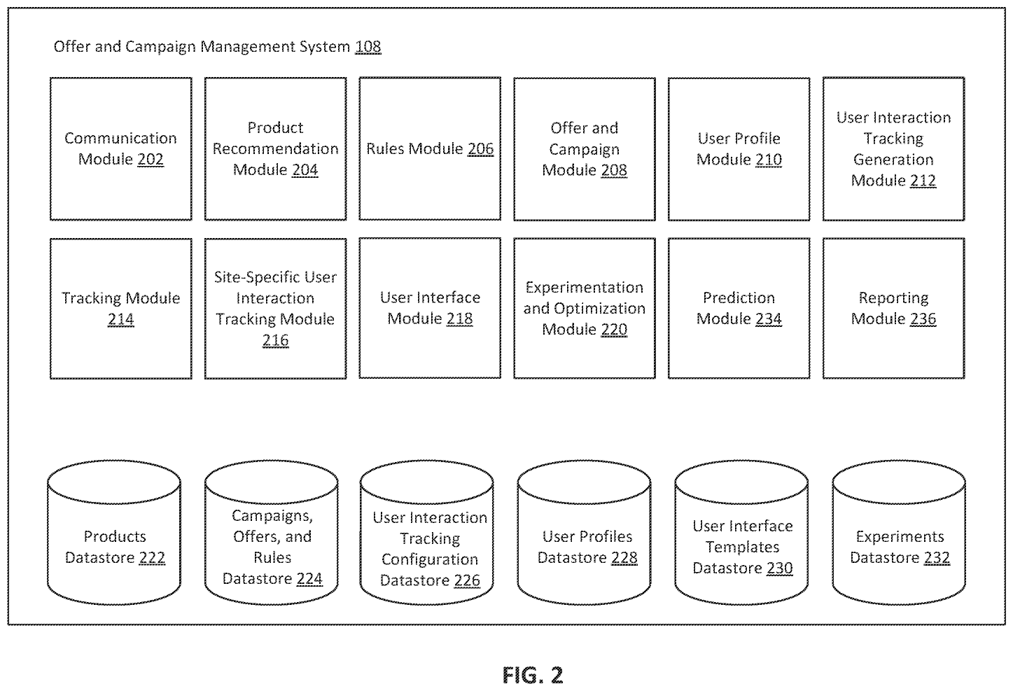

FIG. 2 depicts components of the offer and campaign management system 108 in some embodiments. The offer and campaign management system 108 may include a communication module 202, a product recommendation module 204, a rules module 206, an offer and campaign module 208, and a user profile module 210. The offer and campaign management system 108 may also include a user interaction tracking generation module 212, a tracking module 214, a site-specific user interaction tracking module 216, a user interface module 218, and an experimentation and optimization module 220. The offer and campaign management system 108 may also include a prediction module 234 and a reporting module 236. The offer and campaign management system 108 may also include a products datastore 222, a campaigns, offers, and rules datastore 224, a user interaction tracking configuration datastore 226, a user profiles datastore 228, a user interface templates datastore 230, and an experiments datastore 232.

The communication module 202 may send and/or receive requests and/or data between the offer and campaign management system 108 and any of the website user device 102, the website 104, and the computing system 106. The communication module 202 may receive requests and/or data from any of the website user device 102, the website 104, and the computing system 106. The communication module 202 may also send requests and/or data to any of the website user device 102, the website 104, and the computing system 106.

The product recommendation module 204 may provide product recommendations. The product recommendation module 204 may receive product recommendation requests with parameters. The product recommendation module 204 may weight product recommendations with a given bias using the parameters. For example, the product recommendation module 204 may weight product recommendations towards products or services the user has selected for purchase, products or services that are frequently purchased together, and the best-selling products or services. The product recommendation module 204 may also use the parameters to provide category and brand restrictions and modifiers.

The rules module 206 may receive rule attributes from users and generate rules based on the rule attributes. The rules module 206 may also evaluate offers and a user profile to determine whether to display an offer to the user. The rules module 206 may optionally provide a relevance score based on the evaluation. The offer and campaign module 208 may receive offer attributes from users and generate offers based on the offer attributes. The offer and campaign module 208 may also receive campaign attributes and generate campaigns based on the campaign attributes. The offer and campaign module 208 may provide campaigns and the offers to website users of a website 104.

The user profile module 210 may create and/or update a user profile to include page access by and/or user interaction with a website user with a website 104. The user profile module 210 may include data such as the current and historic shopping cart data, which is data on the products or services the website user has selected for purchase either currently or historically and data such as current and historic sale data, which is data on the products or services the website user has purchased currently or historically, in the user profile. The user profile may also include data such as current and historic landing pages of the website user, current and historic segment records of the website user, location of the website user, weather at the location of the website user, and prediction or predilection scores. The user profile module 210 may also compute or estimate a prediction or predilection score for the website user that estimates a likelihood or a propensity of the website user to purchase a product or service.

The user interaction tracking generation module 212 may generate a site-specific user interaction tracking module 216 for a website 104. The tracking module 214 may receive user interactions from the site-specific user interaction tracking module 216 and provide user interactions to the user profile module 210 for creating and/or updating user profiles. The site-specific user interaction tracking module 216 may detect user interactions with the website 104 and provide such user interactions to the tracking module 214. The site-specific user interaction tracking module 216 may also control the website 104 so as to display a user interface element containing personalized offers and information and to hide the user interface element. The site-specific user interaction tracking module 216 may also control the website 104 so as to display a visual indication of offers and to hide the visual indication of offers. The site-specific user interaction tracking module 216 may also detect offers that the user has interacted with.

The user interface module 218 may display or provide for display user interface elements. The user interface module 218 may use templates, stylesheets (for example, dynamic stylesheets), code (for example, NodeJS server-side code), and custom field definitions to create and/or configure various user interface elements.

The experimentation and optimization module 220 may, given a set of variations and an optimization model, attempt to identify winning variations and automatically weight winning variations. The experimentation and optimization module 220 may also do split tests with no automating winner selection. The experimentation and optimization module 220 may automatically optimize various types of data, such as sets of offers, and content within offers, such as images, titles, subtitles, and/or layouts of offer components.

The prediction module 234 may generate and/or determine predictions based on machine learning and/or artificial intelligence (AI) models. In various embodiments, the prediction module 234 may utilize data from the various datastores of the offer and campaign management system 108, such as the user profiles datastore 228, to generate models and make predictions. For example, the prediction module 234 may utilize a random forest machine learning algorithm to train a set of decision trees. The prediction module 234 may provide a user profile to the set of trained decision trees to generate various predictions related to a propensity or predilection to purchase of a website user.

The reporting module 236 may generate and provide reports, notifications, and/or dashboards that include campaign performance and offer performance as well as other information.

The products datastore 222 may include products data stored, accessed, and/or modified by the product recommendation module 204 or any of the other modules of the offer and campaign management system 108. The campaigns, offers, and rules datastore 224 may include campaigns, offers, and rules data stored, accessed, and/or modified by the offer and campaign module 208 or any of the other modules of the offer and campaign management system 108. The user interaction tracking configuration datastore 226 may include user interaction configuration data stored, accessed, and/or modified by the tracking module 214 or any of the other modules of the offer and campaign management system 108.

The user profiles datastore 228 may include user profile data stored, accessed, and/or modified by the user profile module 210 or any of the other modules of the offer and campaign management system 108. The user interface templates datastore 230 may include user interface templates data stored, accessed, and/or modified by the user interface module 218 or any of the other modules of the offer and campaign management system 108. The experiments datastore 232 may include experiments data stored, accessed, and/or modified by the experimentation and optimization module 220 or any of the other modules of the offer and campaign management system 108.

Each of the products datastore 222, the campaigns, offers, and rules datastore 224, the user interaction tracking configuration datastore 226, the user profiles datastore 228, the user interface templates datastore 230, and the experiments datastore 232 may include any number of data storage structures such as tables, databases, lists, and/or the like.

A module may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, and/or any combination. Software may be executed by one or more processors. Although a limited number of modules are depicted in FIG. 2, there may be any number of modules. Further, individual modules may perform any number of functions, including functions of multiple modules as described herein.

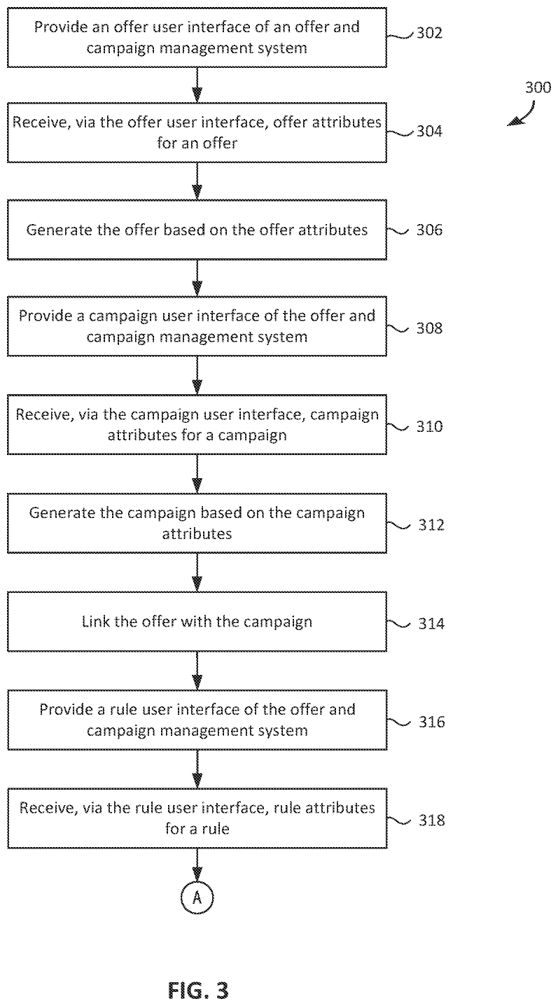

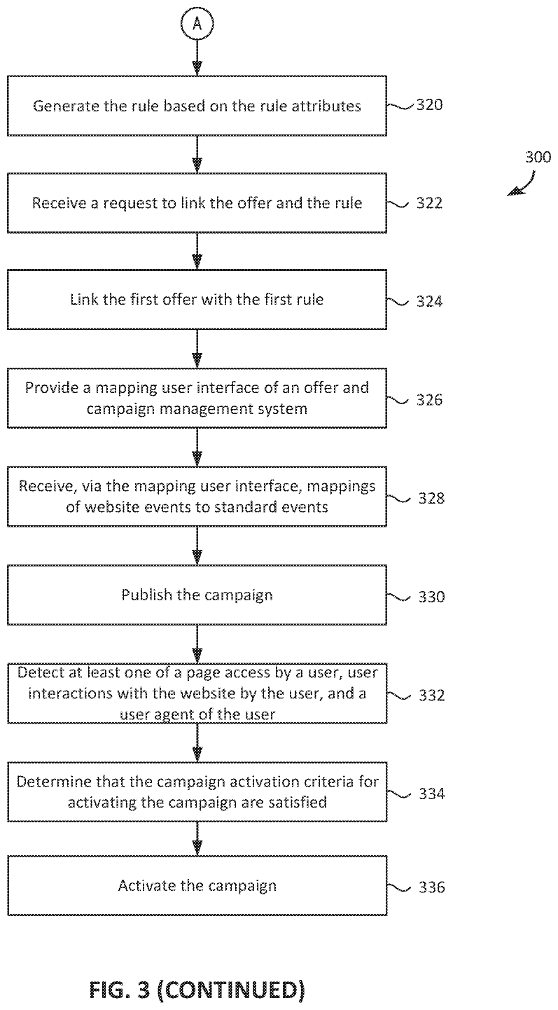

FIG. 3 is a flow diagram depicting a method 300 for providing offer user interfaces, campaign user interfaces, and rule user interfaces for receiving offer attributes for offers, campaign attributes for campaigns, and rule attributes for rules, in some embodiments. The method 300 begins at step 302, where the user interface module 218 provides an offer user interface of the offer and campaign management system 108. The offer user interface is configured to allow the user to provide offer attributes for an offer. The offer attributes may include an offer title, an offer discount code, and an offer tag. The offer and campaign module 208 uses the offer attributes to generate an offer, a visual representation of which the user interface module 218 may display on the website 104.

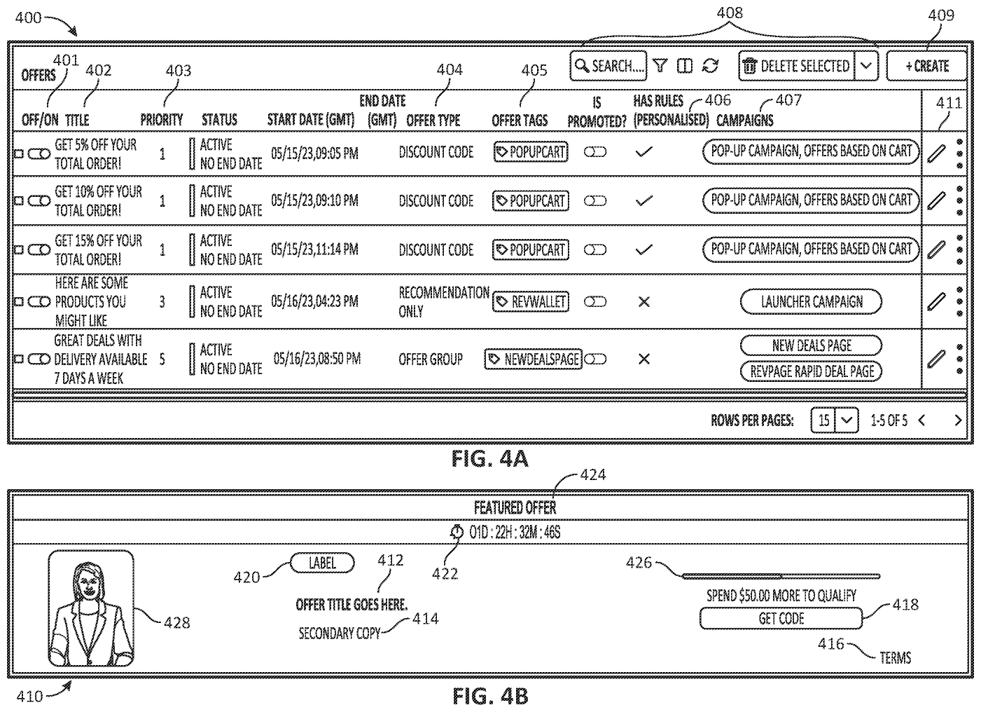

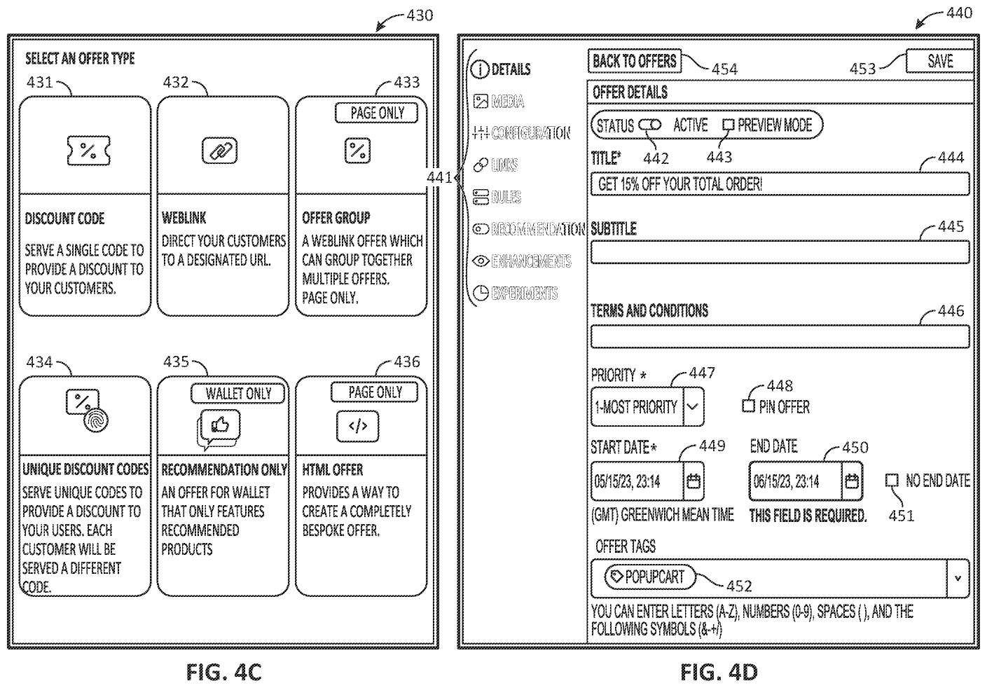

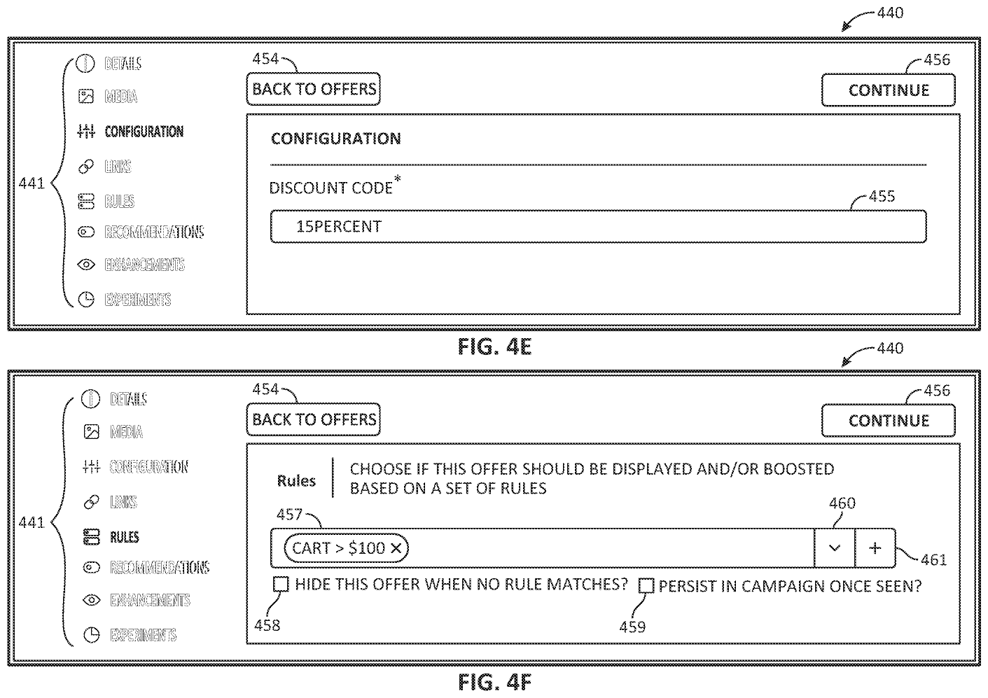

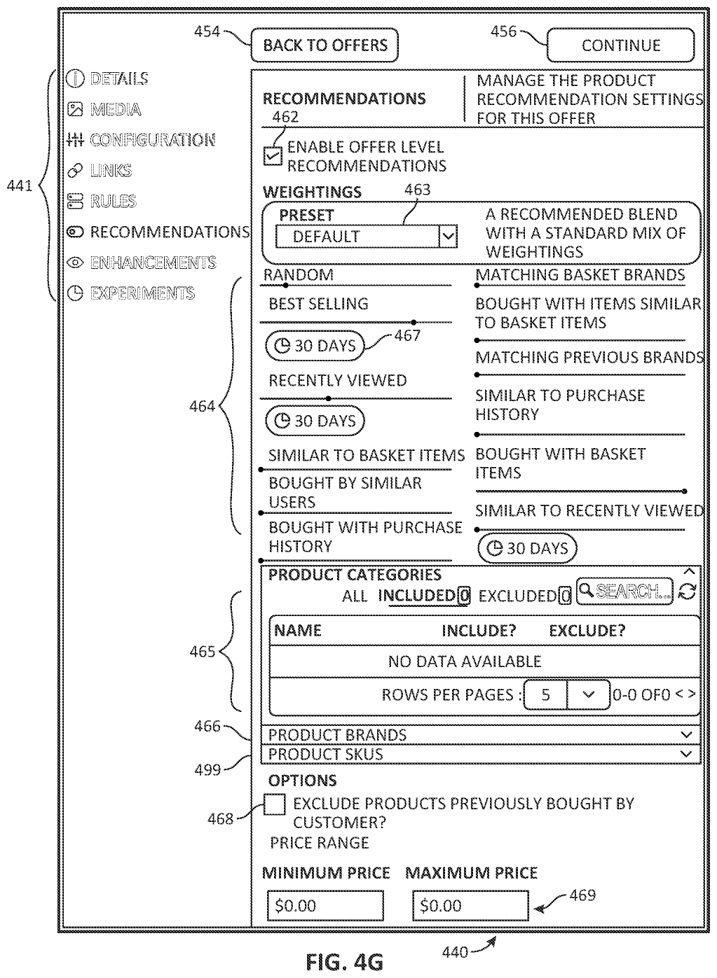

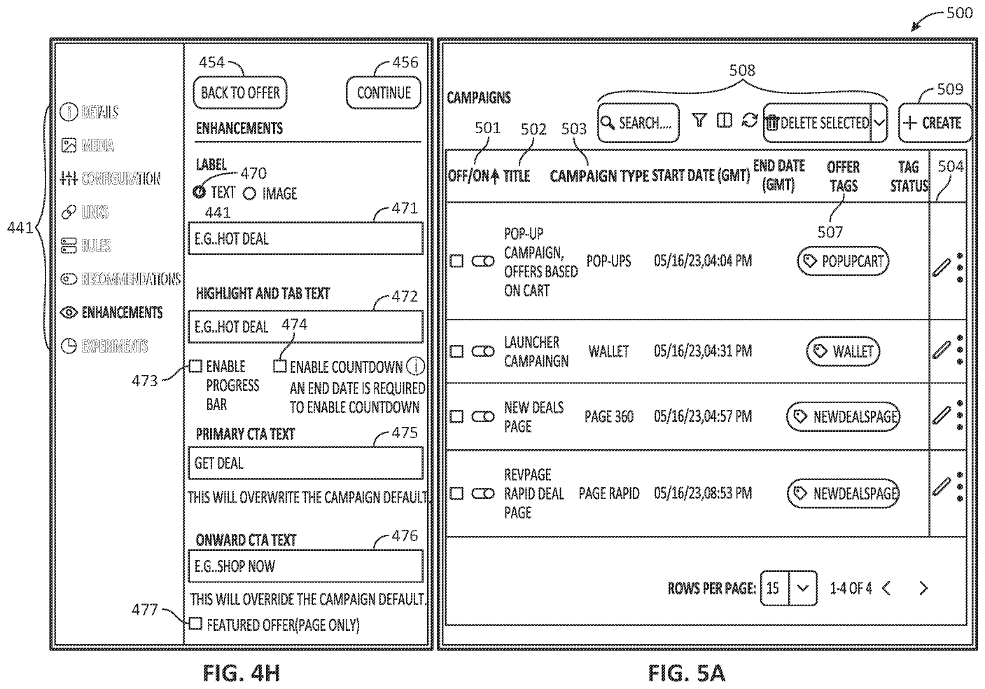

FIG. 4A depicts an example user interface 400 displaying several offers that have been created in the offer and campaign management system 108. The user interface 400 includes multiple columns for displaying attributes of offers. The columns include an off/on column 401 containing a toggle switch that allows a user to toggle an offer on and off, a title column 402 containing a title of an offer, a priority column 403 containing a priority of an offer, an offer type column 404 that contains a type of an offer, and an offer tags column 405 that contains one or more offer tags of an offer. The columns also include a has rules column 406 that indicates whether or not the offer has one or more rules associated with it, a campaigns column 407 that displays one or more campaigns with which the offer is linked, and a column 411 with user interface elements for editing, deleting, or duplicating an offer. The user interface 400 also includes multiple user interface elements 408 for searching offers, filtering offers, selecting columns to be displayed, refreshing the offers displayed in the user interface 400, and deleting selected offers. The user interface 400 also includes a create button 409 for creating an offer.

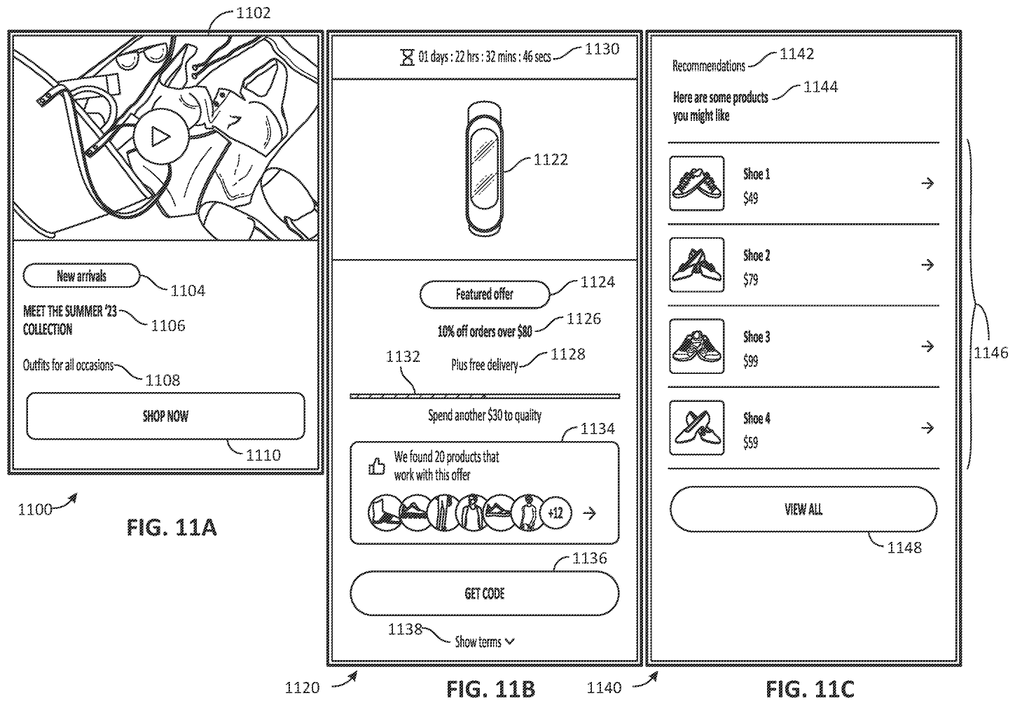

FIG. 4B depicts an example visual representation 410 of an example offer in some embodiments. The visual representation 410 displays offer attributes, including an offer title 412, an offer subtitle 414, a terms and conditions link 416, and a call-to-action button 418. The visual representation 410 further includes a label 420, a countdown 422, a highlight 424, and a progress bar 426. As discussed further herein with reference to, for example, FIG. 4H and FIG. 11B, the countdown 422 may visually indicate an amount of time remaining until the offer expires. The user interface module 218 may update the countdown 422. Also as discussed further herein with reference to, for example, FIG. 4H and FIG. 11B, the progress bar 426 may visually indicate an amount, in a local currency of a website user, of items the website user has to select for purchase in order to obtain a discount code. The visual representation 410 also includes an image 428. Certain of the offer attributes in the visual representation 410 may be optional.

Returning to FIG. 3, at step 304, the offer and campaign management system 108 receives, via the offer user interface, offer attributes for an offer. FIGS. 4C-4H depict example user interfaces for receiving offer attributes for offers in some embodiments. FIG. 4C depicts an example user interface 430 for selecting an offer type. The user interface module 218 may display the user interface 430 after the user selects the create button 409 in FIG. 4A. The user interface 430 allows the user to select one of several types of offers. The different types of offers include a discount code offer 431. A discount code offer 431 provides a discount code to website users of the website 104. The offer types also include a weblink offer 432. The weblink offer 432 may provide a URL to website users of the website 104 so as to direct the website users to the URL. The offer types also include an offer group 433, which can group together multiple offers. The offer types also include a unique discount code offer 434. A unique discount code offer 434 provides unique discount codes to website users of the website 104. The offer types also includes a recommendation only offer 435. The recommendation only offer 435 provides recommended products to website users. The offer types also include an HTML offer 436. An HTML offer 436 is one that is created using HTML provided by the user.

The offer and campaign management system 108 may allow the user to create offers of offer types other than those displayed in the user interface 430 of FIG. 4C. For example, the offer and campaign management system 108 may allow a user to create an email capture offer. An email capture offer may provide a website user with a discount code in exchange for the website user providing their email address.

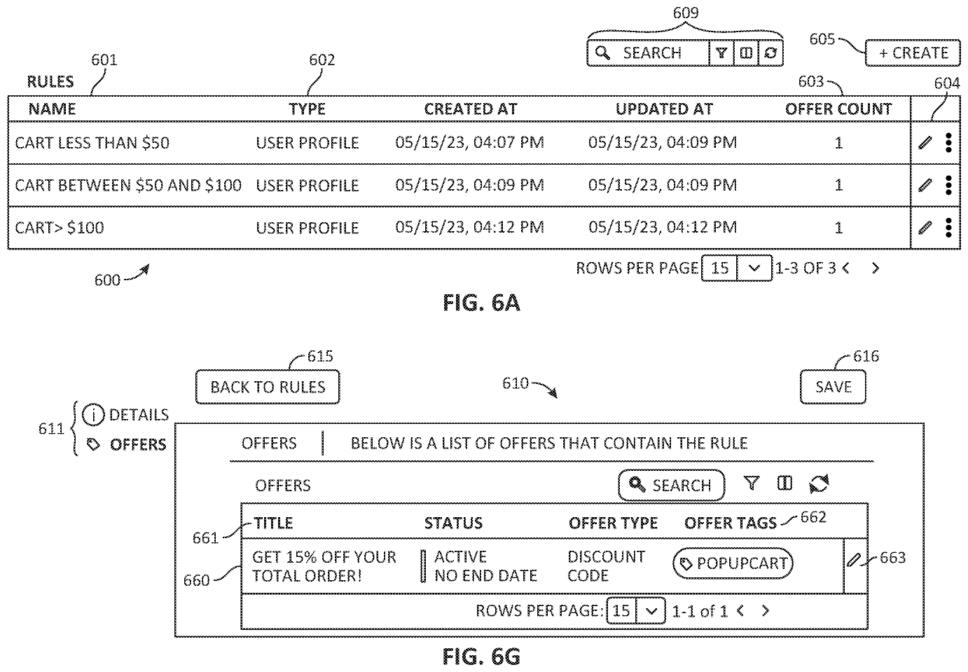

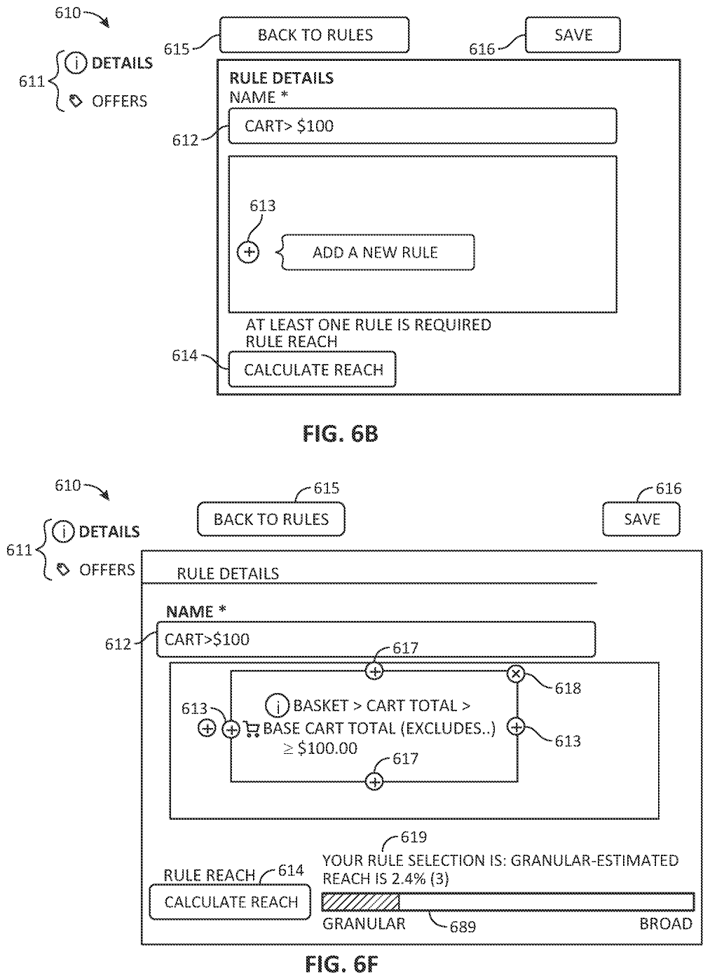

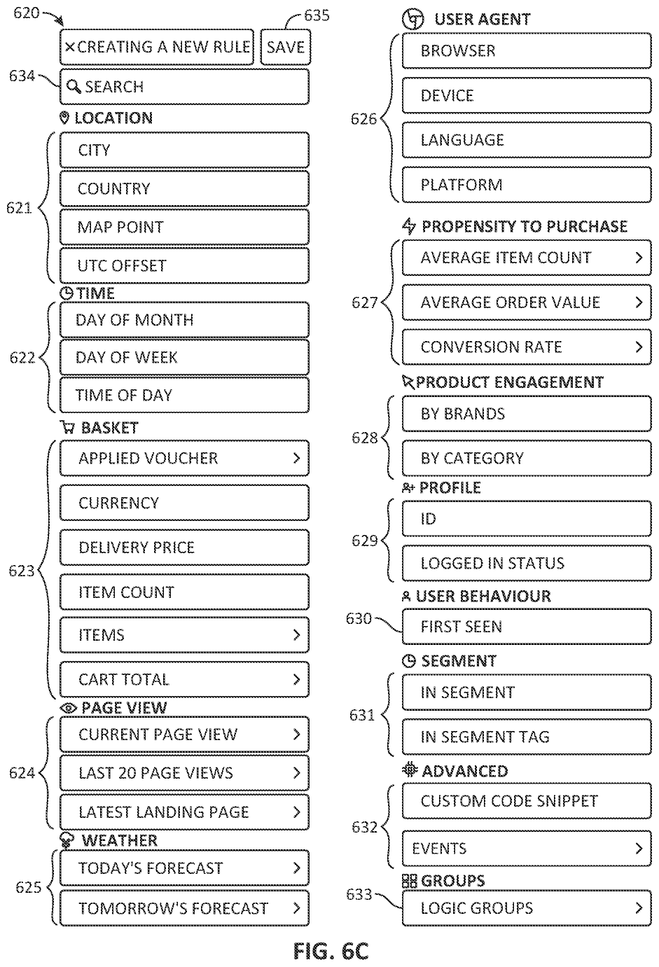

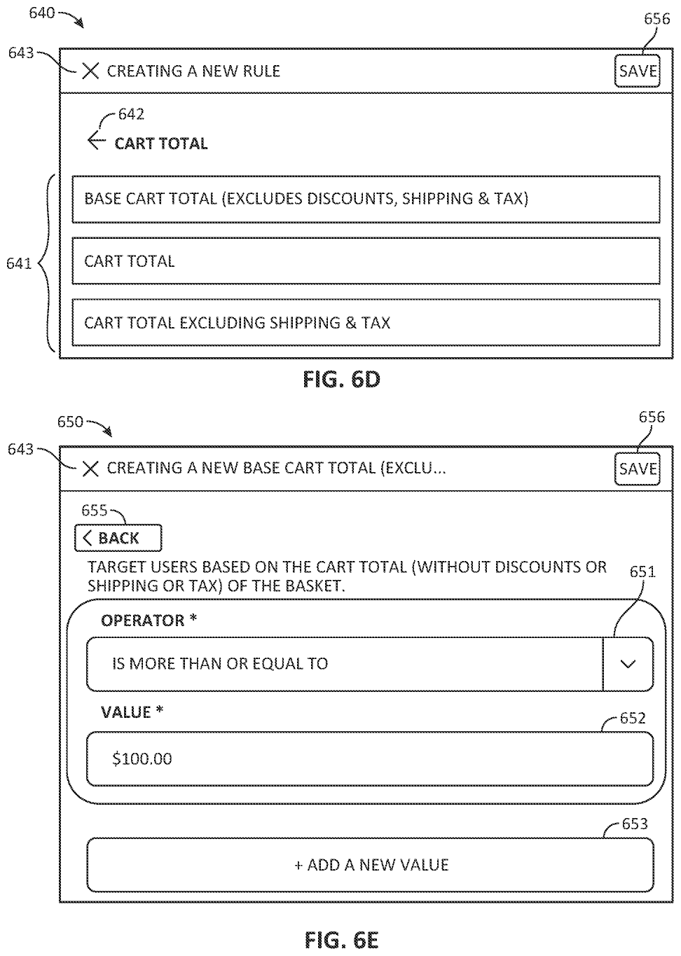

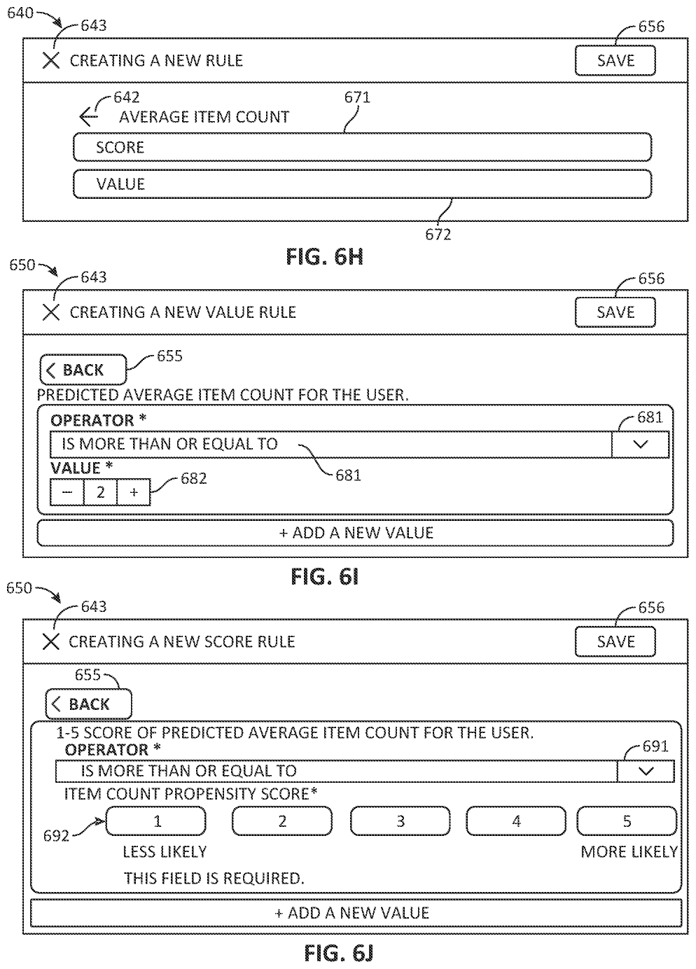

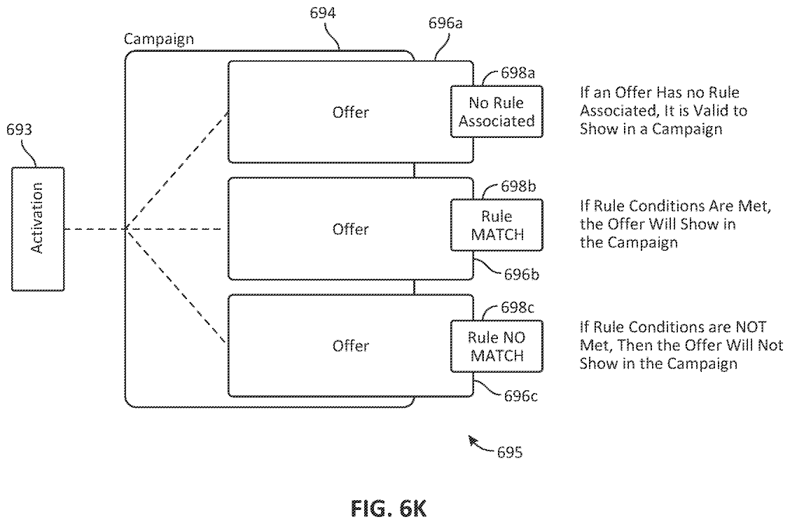

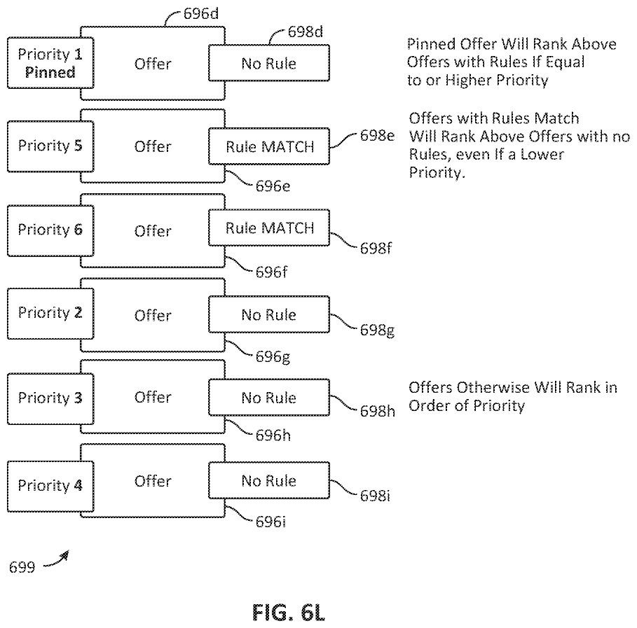

FIG. 4D depicts an example user interface 440 for receiving offer attributes for offers. The user interface module 218 displays the user interface 440 after the user has selected an offer type in the user interface 430. The user interface 440 includes a navigation 441 that includes links that allows the user to navigate among different sections of the user interface 440. The user interface 440 also includes multiple user interface elements and is configured to allow the user to provide offer attributes for the offer. These attributes include an offer title in text field 444, an offer subtitle in text field 445, and terms and conditions for the offer in text field 446. The user may also specify a priority of the offer using the drop-down 447. In some embodiments, the priority of the offer may range from 1 to 20, with 1 being the highest priority and 20 being the lowest priority. The user may pin the offer by selecting the checkbox 448. If the user selects the checkbox 448, the user interface module 218 will display the offer at the top of any offer lists in which the offer appears. Priorities of offers and pinning offers are discussed in more detail with reference to, for example, FIG. 6L.

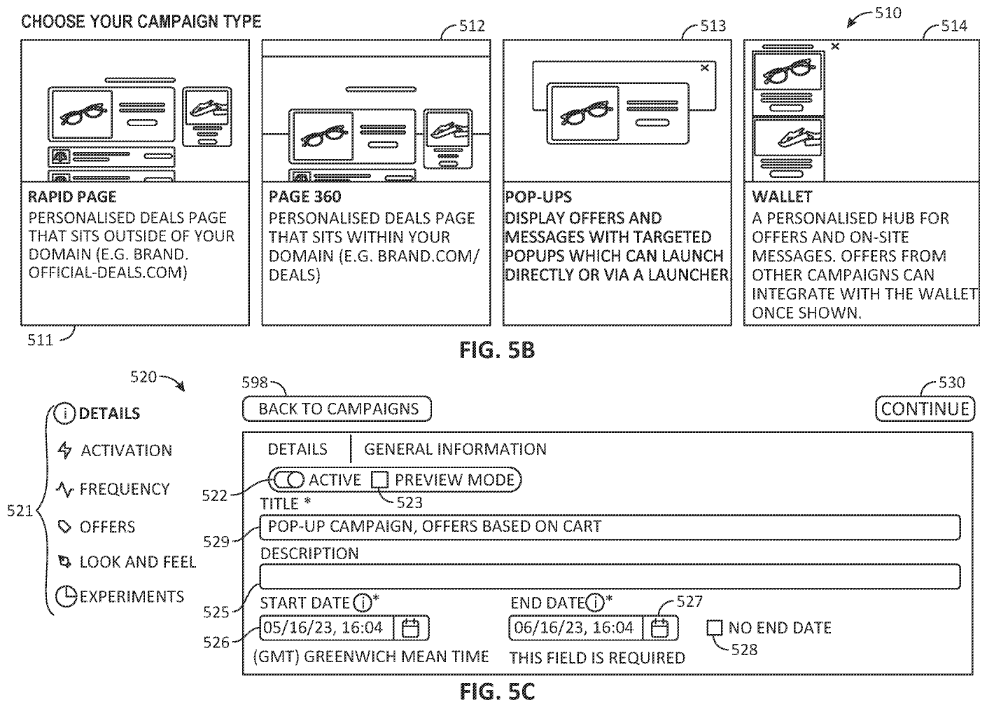

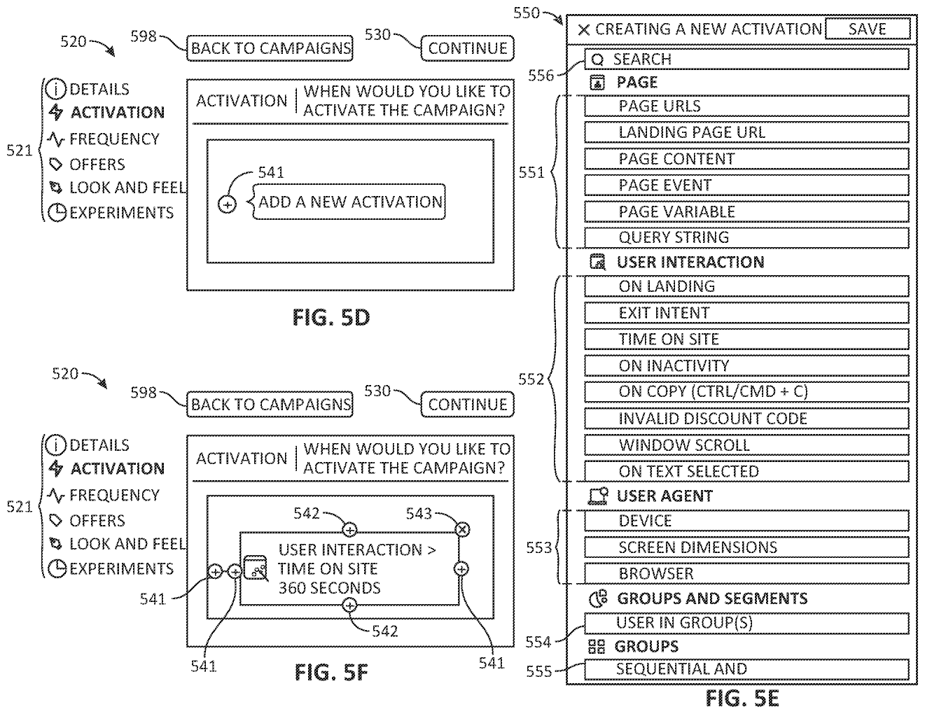

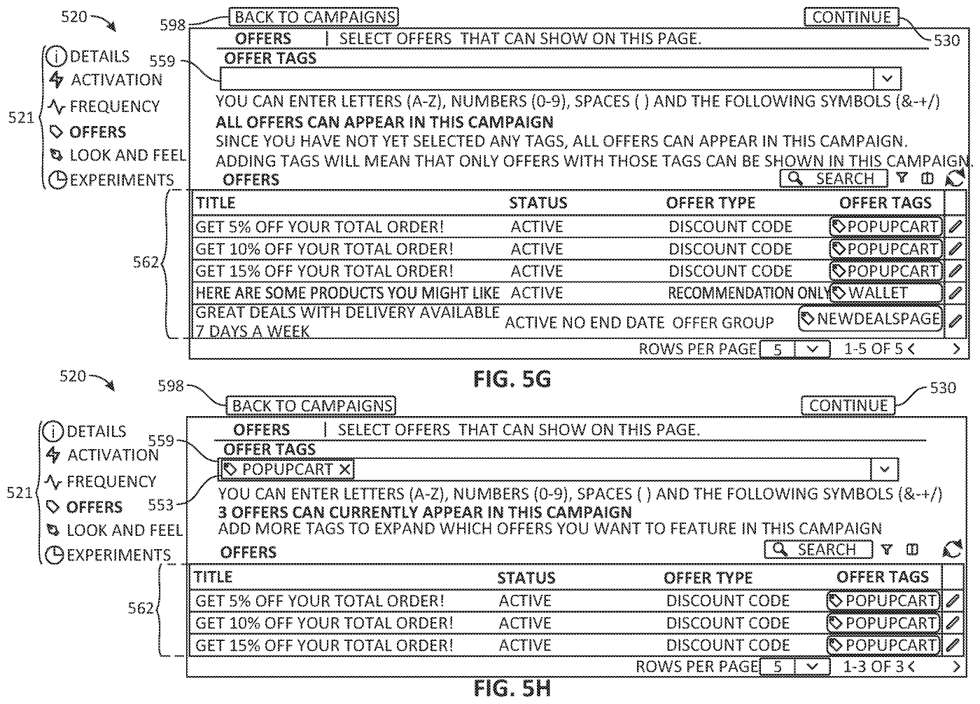

The user may specify a start date for the offer using the start date and time selector 449 and an end date for the offer using the end date and time selector 450. If the user desires that there is no end date for the offer, the user may select checkbox 451. The user may assign one or more offer tags to the offer in user interface element 452. As discussed further herein with reference to, for example, FIGS. 5G and 5H, the offer and campaign management system 108 may link offers to campaigns using offer tags. The user may toggle whether or not the offer is active by using the toggle 442. The user may also choose to put the offer in preview mode by selecting the checkbox 443. If the user selects the checkbox 443, then the offer and campaign module 208 places the campaign in a preview mode. In the preview mode, the user interface module 218 will only display the offer on the website 104 if the URL request by the website user device 102 includes a particular code. If the URL request does not include the particular code, then the user interface module 218 will not display the offer on the website 104. The user may save the offer attributes by selecting the save button 453. The user may return to the offer list interface of FIG. 4A by selecting the button 454. The user may navigate among the different sections of the user interface 440 by using links included in the navigation 441.

FIG. 4E depicts the user interface 440 after the user has selected the configuration link in the navigation 441. The user interface 440 includes a text field 455 into which the user may provide a discount code. After providing the discount code, the user may select the button 456 to continue providing offer attributes.

FIG. 4F depicts the user interface 440 after the user has selected a rules link in the navigation 441. The user interface 440 includes a dropdown 457 that allows the user to link the offer with one or more rules. If the offer has been linked with one or more rules, the dropdown 457 displays a name of each rule that has been linked with the offer. The user may select one or more existing rules using the dropdown arrow 460 or may type in a rule name in the text field of the dropdown 457 to select the rule. The user may request to create a new rule using the plus icon 461. Receiving a request to create a new rule is discussed with reference to, for example, FIGS. 6A-J. The user may select that the offer should be hidden when no rule matches by selecting checkbox 458. The user may specify that the offer should continue to be seen in the campaign once it has been seen by selecting the checkbox 459.

FIG. 4G depicts the user interface 440 after the user has selected a recommendations link in the navigation 441. The user interface module 218 displays user interface elements that allow user to specify options for product recommendations that may be shown in offers. The user may select that product recommendations should be enabled for the offer by selecting the checkbox 462. The user may specify how product recommendations should be weighted using the weightings 464. The weightings 464 include a random weighting, a bought with items similar to basket items weighting, a similar to basket items weighting, a bought with basket items weighting, a matching basket brands weighting, a recently viewed weighting, a similar purchase history weighting, a bought with purchase history weighting, a best-selling weighting, a matching previous brands weighting, a bought by similar users weighting, and a similar to recently viewed weighting. The user may manually adjust the weightings 464 by using slider user interface elements. The user may also select from among several presets for weightings for product recommendations using the drop-down 463. The presets include a default preset, a site weightings preset, a complement basket preset, a best-selling preset, a look like other products preset, a look like products similar users preset, related to previous purchases preset, and recently viewed preset. Selecting a preset adjusts the weightings automatically. For certain presets, the user has the ability to specify the time range used for the weighting period. For example, for the best-selling weighting, the user may specify the time range using the button 467.

The product recommendation module 204 receives the weightings and uses the received weightings to select products to recommend for website users. The product recommendation module 204 may use positions of the slider user interface elements to determine how to allocate weightings for selecting products to recommend for website users.

The user may also specify that certain product categories, product brands, and product SKUs, are included or excluded. For example, the user may specify that certain product categories are included or excluded using the user interface elements 465. The user may specify that certain product brands are included or excluded in product recommendations using user interface elements 466. The user may specify that certain product SKUs are included or excluded using the user interface elements 499. The user may specify that products previously bought by the customer are to be excluded from product recommendations by selecting the checkbox 468. The user may also specify a minimum price and a maximum price for products to be recommended using the text fields 469.

FIG. 4H depicts the example user interface 440 after the user has selected the enhancements link in the navigation 441. The user can specify several enhancements for an offer. For example, the user can specify a label for the offer using radio buttons 470. A label may be either a test label or an image label. If the label is a text label, the user may enter the text for the label in text field 471. The user may specify a highlight for the offer using the text field 472. The user may enable a progress bar for the offer by selecting the checkbox 473. The user may enable a countdown for the offer by selecting the checkbox 474. An end date for the offer is required to enable a countdown for the offer. The user may specify the primary call to action text using text field 475, and the onward call to action text using the text field 476. The user may also specify that the offer is to be a featured offer by selecting the checkbox 477.

The user may also specify experiments for the offer by selecting the experiments link in the navigation 441. The user may set up experiments using different variables, such as the offer title and/or the offer subtitle. The user may select from several optimization goals. One optimization goal is as a split goal, where all variables within an experiment will be split equally between user impressions. Another optimization is based on average order value, where any experiments will automatically weight user impressions towards the waiting variable, based on average order value. Another optimization is based on conversion rate, where any experiments will automatically weight user impressions towards the winning variable based on conversion rate. Another optimization is based on user value, where any experiments will automatically weight user impressions towards the winning variable based on user value.

Returning to FIG. 3, at step 306, the offer and campaign module 208 generates the offer based on the offer attributes the user provided for the offer via the offer user interface as illustrated in FIGS. 4C-4H. At step 308, the offer and campaign module 208 provides a campaign user interface of the offer and campaign management system 108. The campaign user interface is configured to allow the user to provide campaign attributes for a campaign. A campaign is the mechanism by which visual representations of offers may be displayed on the website 104. The campaign attributes may include a campaign title, an offer tag for linking the campaign with one or more offers, and one or more campaign activation criteria for activating the campaign. The one or more campaign activation criteria for activating the campaign include at least one of page access criteria, user interaction criteria user agent criteria.

FIG. 5A depicts an example user interface 500 displaying several campaigns that have been created in the offer and campaign management system 108. The user interface 500 includes multiple columns for displaying attributes of campaigns. The columns include an off/on column 501 containing a switch that allows a user to toggle a campaign on and off, a title column 502 containing a title of the campaign, a campaign type column 503 containing a type of the campaign, and an offer tags column 507 that contains one or more offer tags of the campaign. The columns further include a column 504 with user interface elements for editing, deleting, or duplicating a campaign. The user interface 500 also includes multiple user interface elements 508 for searching campaigns, filtering campaigns, selecting columns to be displayed, refreshing the campaigns displayed in the user interface 500, and deleting selected campaigns. The user interface 500 also includes a create button 509. If the user selects the create button 509, the offer and campaign module 208 receives a request that the user interface module 218 provide user interfaces that allow the user to provide campaign attributes for a new campaign.

Returning to FIG. 3, at step 310, the offer and campaign management system 108 receives, via the campaign user interface, campaign attributes for a campaign. FIGS. 5B-5H depict example user interfaces for receiving campaign attributes for a campaign in some embodiments. FIG. 5B depicts an example user interface 510 for selecting a campaign type in some embodiments. The user interface module 218 may display the user interface 510 after the user selects the create button 509 in FIG. 5A. The user interface 510 allows the user to select one of several types of campaigns. The different types of campaigns include a rapid page 511 campaign type, which is a personalized offers page that sits outside of the domain of the second entity. Another campaign type is a Page 360 512 campaign type, which is a personalized offers page that sits within the domain of the second entity. Another campaign type is a Pop-Up 513 campaign type, which displays offers and messages with targeted pop-ups which can launch directly or via a launcher. Another campaign type is a wallet 514 campaign type, which is a personalized hub for offers and information. Offers from other campaigns can integrate with the wallet once shown. The offer and campaign management system 108 may allow the user to create campaigns of campaign types other than those depicted in the user interface 510 of FIG. 5B.

FIG. 5C depicts an example user interface 520 for receiving campaign attributes for campaigns. The user interface module 218 displays the user interface 520 after the user has selected a campaign type the user interface 510 of FIG. 5B. The user interface 520 is configured to allow the user to provide campaign attributes for the campaign. These campaign attributes include a campaign title in text field 529, a campaign description in text field 525, a campaign start date using a date and time selector 526, and a campaign end date using a date and time selector 527. The user may specify that the campaign is to have no end date by selecting checkbox 528. The user may toggle the campaign on and off using a toggle switch 522 and place the campaign in the preview mode using a checkbox 523. If the user selects the checkbox 523, then the preview mode is selected, then the offer and campaign module 208 places the campaign in the preview mode. In the preview mode, the user interface module 218 will only display offers linked with the campaign on the website 104 if the URL request by the website user device 102 includes a particular code. If the URL request does not include the particular code, then the user interface module 218 will not display any offers linked with the campaign on the website 104. The user may return to the user interface 500 of FIG. 5B by selecting the button 598. The user may continue with the campaign creation by selecting the button 530. The user may navigate among the different parts of the campaign creation using the navigation 521.

FIG. 5D depicts the user interface 520 after the user has selected the button 530 of FIG. 5C or selected an activation link in the navigation 521. The user interface 520 as shown in FIG. 5D allows the user to specify one or more activation criteria for activating the campaign. The user may add new activation criteria by selecting the plus icon 541. FIG. 5E depicts an example user interface 550 that the offer and campaign module 208 displays after the user has selected the plus icon 541 in some embodiments. The user interface 550 includes groups of activation criteria. The user may search the activation criteria using the search text field 556. A first group 551 of activation criteria relates to page access criteria. The first group 551 of activation criteria includes page URLs, landing page URL, page content, page event, page variable, and query string. For example, the user may specify one or more activation criteria related to a page URL. The user may specify that the campaign be activated if the page URL includes or excludes a particular value. As another example, the user may specify one or more activation criteria related to content of the page on the website. The user may specify that the campaign be activated if content on the page includes or excludes a particular value or pattern.

A second group 552 of activation criteria relates to user interactions with the website. The second group 552 of activation criteria includes user interactions related to on landing, exit intent, time on site, on inactivity, on copy, invalid disk code, window scroll, and context selected. For example the user may specify one or more activation criteria related to exit intent exhibited by the user. The user may specify that if the user moves the mouse to the top of the browser or anywhere outside the browser after a certain period of time, the site-specific user interaction tracking module 216 is to activate the campaign. As another example, the user may specify that the site-specific user interaction tracking module 216 activate the campaign if the website user copies text on the page. The website user copying text on the page may occur if the user copies a product name or description in an attempt to search for the product on a shopping website. As another example, the user may specify that the site-specific user interaction tracking module 216 activate the campaign if the website user enters invalid discount code on the website.

A third group 553 of activation criteria relates to a user agent of the website user. The third group 553 includes user agent criteria such as the device the website user is using, the screen dimensions of the device the website users is using, and the browser of the user.

The user may also specify activation criteria related to one or more groups or segments 554 that the user is in. The user may also specify activation criteria related to sequential and groups 555. Sequential and groups 555 relate to one or more activation criteria that have to occur in sequence in order for the site-specific user interaction tracking module 216 to activate the campaign.

FIG. 5F depicts the user interface 520 after the user has selected activation criteria from the second group 552 of user interactions. As illustrated, the user has selected an activation criteria related to the amount of time the website user has spent on the site. After the website user has spent 360 seconds on the website, the offer and campaign management system 108 will activate the campaign. The user may add additional activation criteria by selecting one of the plus icons 541 or one of the plus icons 542. If the user adds additional activation criteria by selecting a plus icon 541, then all of the activation criteria will have to occur in order for the campaign to be activated, i.e., the activation criteria are ANDed. If the user adds additional activation criteria by selecting a plus icon 542, then any of the activation criteria may occur in order for the campaign to be activated, i.e., the activation criteria are ORed. The user may delete an activation criterion by selecting the X icon 543.

The user may select a frequency with which the campaign should occur by selecting a frequency link in the navigation 521. The user may select that the campaign should be shown all the time. If the campaign is not to be shown all the time, the user may select the number of times that it should be shown to the website user per session, or the number of times that it should be shown every period of time, which may be hours, days, or other periods of time, such as weeks or months.

The user may select the offers that are to be linked with the campaign by selecting the offers link in the navigation 521. FIG. 5G displays the user interface 520 after the user has selected the offers link in the navigation 521. The user interface 520 displays in section 562 five offers that may be associated with the campaign. Each of the offers in the section 562 has one or more offer tags. The user may enter one or more offer tags in text field 559. If the user does not enter any offer tags, all offers can appear in the campaign. If the user enters an offer tag, then only offers with that offer tag can be shown in the campaign. FIG. 5H displays the user interface 520 after the user has entered an offer tag in the text field 559. The offer tag, “POPUPCART,” is associated with three offers. Accordingly the three offers can appear in the campaign. In some embodiments, the user interface 520 includes a text field that allows a user to enter one or more offer tags in order to exclude offers that have those offer tags from the campaign.

The user may define a look and feel for the campaign by selecting the look and feel link in the navigation 521. The user may also enable experiments for the campaign by selecting the experiments link in navigation 521. The user can set up experiments based on groups of offers. The user may select from several optimization goals. One optimization goal is as a split goal, where all variables within an experiment will be split equally between user impressions. Another optimization is based on average order value, where any experiments will automatically weight user impressions towards the waiting variable, based on average order value. Another optimization is based on conversion rate, where any experiments will automatically weight user impressions towards the winning variable based on conversion rate. Another optimization is based on user value, where any experiments will automatically weight user impressions towards the winning variable based on user value.

Returning to FIG. 3, at step 312, the offer and campaign management system 108 generates the campaign based on the campaign attributes received via the campaign user interface from the user. At step 314, the offer and campaign management system 108 links the offer with the campaign based on one or more offer tags that the user specified in the text field 559 of FIG. 5G and FIG. 5H.

At step 316, the offer and campaign management system 108 provides a rule user interface of the offer and campaign management system 108. The rule user interface is configured to allow the user to provide to provide rule attributes for a rule which may be linked to one or more offers. The rule attributes include a rule name and one or more rule conditions. FIG. 6A depicts an example user interface 600 displaying several rules that have been created in the offer and campaign management system 108. The user interface 600 includes several columns, such as a rule name column 601 containing a name of a rule and a rule type column 602 containing a type of a rule. The columns also include an offer count column 603 containing a number of offers with which a rule is linked and a column 604 with user interface elements for editing, deleting, or duplicating a rule. The user interface 600 also includes multiple user interface elements 609 for searching rules, filtering rules, selecting columns to be displayed, and refreshing the rules displayed in the user interface 600. The user interface 600 also includes a create button 605. If the user selects the create button 605, the rules module 206 receives a request that the user interface module 218 provide user interfaces that allow the user to provide rule attributes for a new rule.

Returning to FIG. 3, at step 318, the offer and campaign management system 108 receives, via the rule user interface, rule attributes for a rule. FIG. 6B displays an example user interface 610 that the user interface module 218 displays after the user has selected the create button 605 of FIG. 6A. The user interface 610 includes a text field 612 where the user may specify a name of the rule. The user may also add one or more conditions to the rule by selecting the plus icon 613. If the user selects the plus icon 613, the user interface module 218 may display a user interface that allows the user to select one or more rule conditions for the rule. The user may go back to the user interface 600 of FIG. 6A by selecting the button 615 and save the rule by selecting the button 616.

FIG. 6C depicts an example user interface 620 for allowing the user to select one or more rule conditions. The user interface 620 contains numerous options for specifying conditions for the rule. The user interface 620 also includes a search text field 634 for searching options and a button 635 for saving selected options. The options include location options 621, where the user may specify conditions related to a city country map point or UTC offset of the website user. The options also include time options 622, where the user may specify conditions related to the day of the month, the date of the week, or the time of day that the website user is browsing the website.

The options also include options 623 related to the basket (also referred to as a cart) of the website user. These options include whether the user has applied a voucher, a currency of the user, a delivery price of the items the website user has selected for purchase, a count of the items in the basket of the website user, actual items in the user's website basket, and a total of amount of items in the website user's basket. The options also include options 624 related to the current page view of the website user, the last 20 page views of the website user, and the latest landing page of the website user. The options also include options 625 related to weather at a location of the website user, such as the forecast of the day or the forecast of the day after the date the website user is browsing the website.

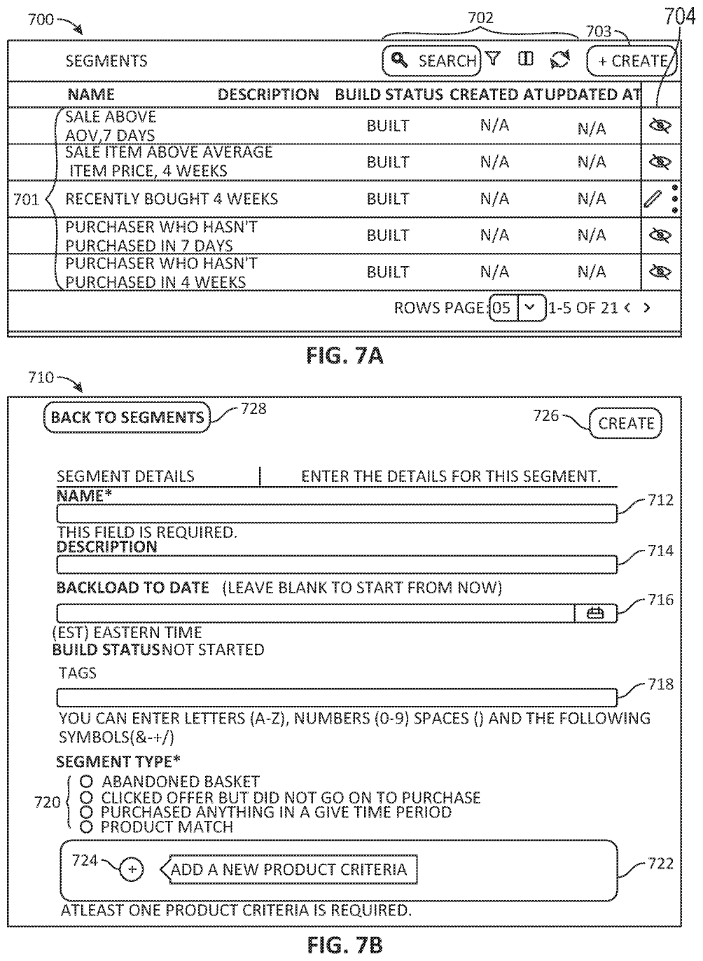

The options also include options 626 related to a user agent of the website user, such as a browser of the website user, a device of the website user, a language of the website user, and a platform of the website user. The options also include options 627 related to a propensity to purchase of the website user. These options include an average item count, an average order value, and a conversion rate. The options also include product engagement options 628, which may be specified by particular brand or by particular categories. The options also include profile options 629, which may be specified by user ID or by user logged-in status. The options also include user behavior options 630, such as a time the user was first seen. The options also include options 631 related to segments, such as whether the user is in a particular segment or in a particular segment tag. Segments are discussed in more detail with reference to, for example FIGS. 7A and 7B. The options also include advanced options 632. Advanced options 632 may allow the user to provide a custom code snippet in a language such as JavaScript and to define conditions based on events. The options also include options 633 related to logic groups.

FIG. 6D depicts an example user interface 640 that the user interface module 218 displays if the user selects an option related to the website user's shopping cart, such as the cart total. The user may select from among options 641 related to the cart total of the website user. These include a base cart total, which excludes discounts, shipping, and tax, a cart total, and a cart total excluding shipping and tax. The user may select one of the options 641 and save the option by selecting the save button 656. The user may return to the user interface 610 of FIG. 6B by selecting the X icon 643. The user may return to the user interface 620 of FIG. 6C by selecting the left arrow 642.

FIG. 6E depicts an example user interface 650 that the user interface module 218 displays after the user has selected one of the options 641 of FIG. 6D. The user may specify the operator by selecting the drop-down 651 and specify the value in text field 652. The user may add new values by selecting the button 653. The user may return to the user interface 640 of FIG. 6D by selecting the back button 655. The user may save the option by selecting the save button 656. The user interface module 218 may provide the user interface 640 and/or the user interface 650 for certain other options in FIG. 6C.

After the user has specified one or more rule conditions, the user interface module 218 displays the user interface 610 as depicted in FIG. 6F. The rule includes the rule condition that the cart total, which excludes discounts, shipping, and tax, has to be greater than or equal to $100. The user may remove the rule condition by selecting the X icon 618. The user may add OR rule conditions by selecting the plus icon 617 and may add AND rule conditions by selecting the plus icon 613.

The user may request that the rules module 206 calculate an estimated reach of the rule by selecting the calculate reach button 614. If the user selects the calculate reach button 614, the rules module 206 receives a request to calculate an estimated reach of the rule. The rules module 206 evaluates the rules against user profiles of website users who have accessed the website 104. The rules module 206 calculates an estimated reach of the rule based on the evaluation of the rule against the user profiles of website users who have accessed the website 104. The user interface module 218 displays a visual indication 689 of the estimated reach of the rule. In some embodiments, the visual indication 689 is a rectangle that the user interface module 218 fills in to represent the calculated reach of the rule, ranging from granular (may only reach a small number or percentage of website users) to broad (may reach a large number or percentage of website users). The user interface module 218 may also display text 619 indicating reach of the rule, which may include an estimated percentage of website users to whom the rule condition may apply, as well as an estimated number of website users over a particular time period, such as one day, to whom the rule condition may apply.

Returning to FIG. 3, at step 320, the rules module 206 generates the rule based on the rule attributes received via the rule user interface. At step 322, the offer and campaign management system 108 receives a request to link an offer with a rule. The user may request that the offer and campaign management system 108 link the offer with the rule using the user interface 440 as depicted in FIG. 4F. At step 324 the offer and campaign management system 108 links the offer with the rule. FIG. 6G depicts the user interface 610 that the user interface module 218 displays if the user selects the offers link in the navigation 611. The user interface 610 includes a section 660 listing the offers that are linked with the rule. The section 660 includes a title column 661 that displays the offer title of the offer linked with the rule and an offer tags column 662 that displays the offer tags of that offer. The section 660 also includes an edit offer icon 663 for each offer. Selecting the edit offer icon 663 causes the user interface module 218 to display the user interface 440 depicted in, for example, FIGS. 4D-H, thereby allowing the user to edit the offer.

Prior art systems implement offers, campaigns, and rules in a unitary way, meaning that an offer, a campaign, and a rule are integrated and each can not be treated individually. Furthermore, an offer has a one to one relationship with a campaign, and a rule has a one to one relationship with an offer. Such an approach creates several technical problems. One technical problem is that making changes to one of an offer, a rule, and a campaign necessarily changes the other components to which the changed component is linked. Another technical problem is that an offer in a campaign cannot be reused for use in a different campaign, and a rule for an offer cannot be reused for use in a different offer. The technical solutions that the offer and campaign management system 108 provides is to treat offers, campaigns, and rules as individual business objects and to use offer tags to link offers with campaigns and rules with offers. This approach allows users to modify an offer, a rule, or a campaign without modifying the other linked components. This approach also allows users to reuse an offer in a campaign different from the original campaign to which the offer was, and to reuse a rule in an offer different from the original offer to which the rule was linked.

FIGS. 6H-J depict example user interfaces for creating rules based on a propensity, or predilection, of a website user to purchase items. FIG. 6H depicts the user interface 640 of FIG. 6D after the user has selected the average item count rule condition option in the user interface 620 of FIG. 6C. The user interface 640 allows a user to select either a score 671 or a value 672 of the average item count for the website user. If the user selects the value 672, the user interface module 218 displays the user interface 650 as illustrated in FIG. 6I. The user interface 650 allows the user to select an operator, which may be more than or equal to or less than or equal to using the dropdown 681 and a value using the text field 682. In FIG. 6H, if the user selects the score 671, the user interface module 218 displays the user interface 650 as illustrated in FIG. 6J. The user can select an operator using dropdown 691 and an item count propensity score using one of the buttons 692. Selecting a particular button of the buttons 692 has the effect of also selecting buttons with values greater than that of the particular button selected.

As discussed in further detail herein, for each website user of the website 104, the site-specific user interaction tracking module 216 detects interactions of the website user with the website 104 and creates or updates a user profile of the website user. For rule conditions related to the website user's propensity, or predilection, to purchase, the prediction module 234 may apply one or more machine learning (ML) or artificial intelligence (AI) algorithms that have been trained on data in the datastores of the offer and campaign management system 108, such as the user profiles datastore 228, to user profiles of website users with the website 104 and/or other websites. To determine or estimate a website user's propensity to purchase, the prediction module 234 may apply such ML or AI algorithms to the user profile of the website user to obtain a score, a likelihood, or other value that indicate the propensity. For example, the prediction module 234 may estimate an average number of items the website user may select for purchase. As another example, the prediction module 234 may estimate an average order value for the website user. As another example, the prediction module 234 may estimate a conversion rate for the website user.

The user may set up one or more rules based on the propensity of a website user using the user interfaces illustrated in FIGS. 6H-J and link the one or more rules with one or more offers linked to a campaign. As the website user browses the website 104, the prediction module 234 may apply ML or AI algorithms to the user profile of the website user to estimate an average number of items the website user may select for purchase, an average order value of the website user, and/or a conversion rate for the website user. After the campaign has been activated, the user interface module 218 may show the one or more offers to the website user if the rules based on the propensity of the website user are satisfied. For example, the prediction module 234 may estimate that the average order value of the user is $42. If a rule has been created for an average order value exceeding $40 and the rule linked to an offer of a five percent discount for orders above $40, the user interface module 218 may display the offer to the website user.

In some embodiments, in addition to or as an alternative to using data from the website 104, the prediction module 234 may use data from multiple websites 104 of multiple entities that utilize the offer and campaign management system 108. One advantage of using data from multiple websites 104 is that the prediction module 234 may train on larger amounts of data, and thus be able to make more accurate predictions. The prediction module 234 may anonymize or otherwise de-identify the data so that website users may not be able to be identified.

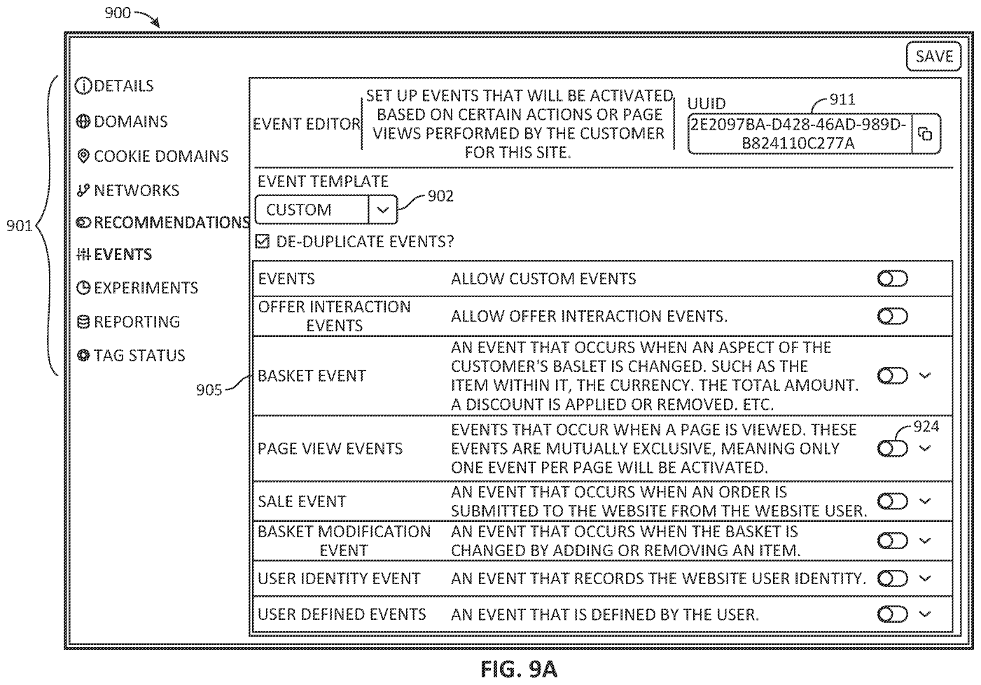

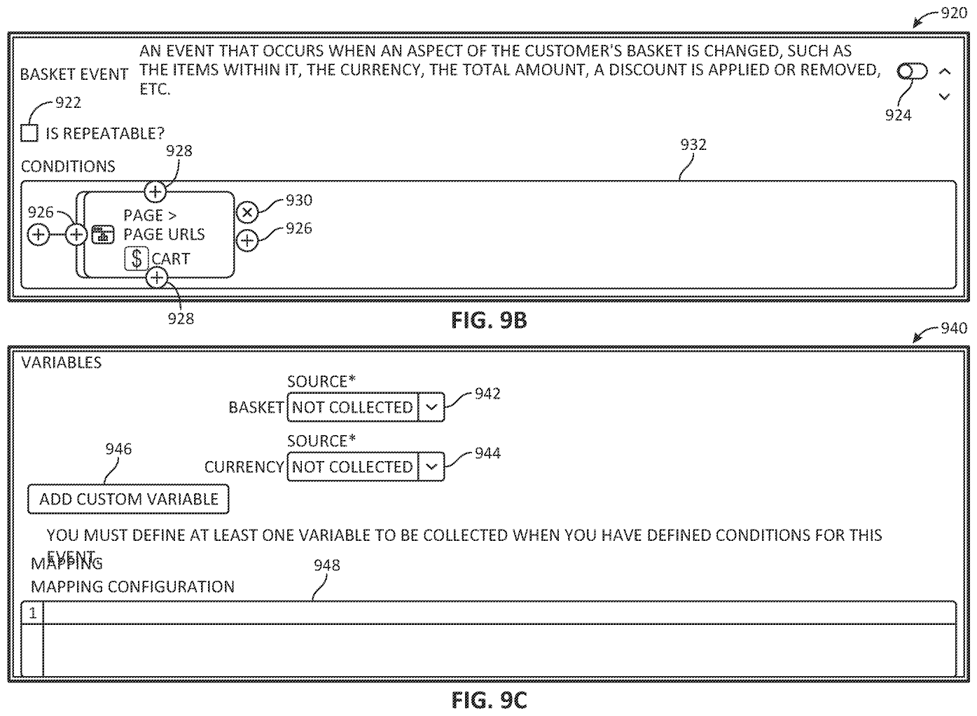

Returning to FIG. 3, at step 326 the user interface module 218 provides a mapping user interface of the offer and campaign management system 108. FIG. 9A depicts an example user interface 900 for providing a mapping user interface and for receiving mappings of website events to standard events in some embodiments. The user interface 900 includes a navigation 901, an event template drop-down 902, and a UUID 911 (universally unique identifier). The user may select an event template using the event template drop-down 902. For example, an event template may be provided that corresponds to an e-commerce platform such as Shopify or Adobe Commerce. If the user selects a custom event template using the event template drop-down 902, the user interface module 218 displays user interface elements that allow the user to toggle on or off events and/or to specify mappings for events. The user interface elements include a basket event 905 that allows the user to specify events that will be activated based on certain actions or page views performed by a website user that relate to the cart of the website user.

FIG. 9B depicts an example user interface 920 that the user interface module 218 displays if the user selects the basket event 905. The user interface 920 includes a toggle 924 to toggle the basket event on or off, a checkbox 922 to specify whether or not the basket event is repeatable, and a user interface element 932 for providing one or more conditions for the basket event. The user may add conditions that are ANDed by selecting the plus icon 926 or conditions that are ORed by selecting the plus icon 928. The user may delete a condition by selecting the X icon 930.

FIG. 9C depicts an example user interface 940 for receiving mappings of basket events in some embodiments. The user interface 940 includes a basket source drop-down 942 that allows the user to specify the source of basket variables. The options of the basket source drop-down 942 include DOM selector, global variable, AJAX request, cookie, JSON schema, XPath, and not collected. The user interface 940 also includes a currency source drop-down 944 that allows the user to specify the source of currency variables. The options of the currency source drop-down 944 include DOM selector, global variable, AJAX request, cookie, JSON schema, XPath, and not collected. Both the basket source drop-down 942 and the currency source drop-down 944 may include fewer or more options. The user interface 940 also includes a button 946 that allows the user to request that a custom variable be added. The user interface 940 also includes a text field 948. The user may provide a mapping configuration for basket events in the text field 948. In some embodiments, the tracking module 214 utilizes a standard schema to create and update user profiles. The user may provide a mapping configuration so that basket events on the website 104 may be mapped to corresponding fields of the standard schema. In some embodiments, when the site-specific user interaction tracking module 216 detects basket events on the website 104, the site-specific user interaction tracking module 216 sends the basket events to the tracking module 214. The tracking module 214 utilizes the mapping configuration to transform basket events on the website 104 to the corresponding fields of the standard schema, and thus create or store a user profile.

The user interface module 218 may provide similar interfaces for the other events listed in the user interface 900 of FIG. 9A. Such other events include page view events, such as an impression event, a product view event, and a page view event. An impression is an event that occurs when a page that contains many products, such as when a search result or category listing page is viewed. A product view event is an event that occurs when a page is viewed that contains a product. A page view event is an event that occurs when any page is viewed. Page view events may be mutually exclusive, meaning that only one event per page will be activated.

The other events also include a sale event, a basket modification event, the user identity event, and user-defined events. A sale event is an event that occurs when an order is submitted to the user from the website. A basket modification event is an event that occurs when the basket is changed by adding or removing an item. The user identity event is an event that records the user identity. A user defined event is an event that is defined by the user. For page view events, sales events, and basket modification events, but user interface module 218 may provide user interfaces (not illustrated in FIGS. 9A-9C) that are similar to the user interface 920 and the user interface 940. For both user identity events and user-defined events, the user may provide user interfaces (not illustrated in FIGS. 9A-9C) to allow the user to add collectors.

Returning to FIG. 3, at step 328 the tracking module 214 receives, via the mapping user interface, mappings of website events to standard events. In some embodiments, if the website 104 utilizes an e-commerce shopping platform such as Shopify or Adobe Commerce, the offer and campaign management system 108 may provide a plug-in or other module that integrates with the e-commerce shopping platform. The plug-in or other module may automatically map events detected on the website 104 to events in a standard schema or format. In some embodiments, the user may not have to provide mappings of website events to events in the standard schema or format.

Prior art systems may collect data from multiple websites and store the data in the format particular of each website. As the data from each website is stored in its own particular format, it may be difficult to utilize the aggregate data from multiple websites. This approach creates the technical problem that the collected data cannot be utilized in real-time. The offer and campaign management system 108 provides a technical solution to this technical problem by allowing for the data from each website to be mapped to a standard format or schema. Such mapping may be done using the user interfaces illustrated in FIGS. 9A-9C or by use of a plug-in. This approach allows the offer and campaign management system 108 to collect data in the format of the website it is integrated with and transform it in real-time or near real-time to a standard schema or format. This allows the offer and campaign management system 108 to create and update user profiles in real-time or near real-time. Because user profiles are created and updated in real-time or near real-time, the offer and campaign management system 108 may evaluate the user profiles against stored rules linked with offers so as to determine what offers to display to website users.

At step 330 the offer and campaign module 208 publishes the campaign. The offer and campaign module 208 may publish the campaign by causing the user interaction tracking generation module 212 to generate the site-specific user interaction tracking module 216 for the website 104. The site-specific user interaction tracking module 216 may include executable instructions for execution by the website user devices 102 of users who access the website. The executable instructions may include one or more campaign activation criteria for activating the campaign. In some embodiments, the executable instructions may be or include a tag. In some embodiments, the tag may include code, such as client-side JavaScript code, that executes on a website user device 102. In some embodiments, the offer and campaign management system 108 may store the site-specific user interaction tracking module 216 and the offer and campaign module 208 may provide a reference to the site-specific user interaction tracking module 216 for inclusion in the executable instructions of the website 104. In such embodiments, browsers executing on the website user device 102 obtain the site-specific user interaction tracking module 216 via the reference in the executable instructions of the website 104.

At step 332, the site-specific user interaction tracking module 216 detects at least one of a page access by a user, user interactions with the website by the user, and a user agent by the user. At step 334 the site-specific user interaction tracking module 216 determines that at least one of the page access by the user, the user interactions with the website by the user, and the user agent of the user satisfy the one or more campaign activation criteria for activating the campaign. At step 336 the site-specific user interaction tracking module 216 activates the campaign.

FIG. 6K is a block diagram 695 depicting an activation 693 of a campaign 694, multiple offers 696, and multiple rules 698 in some embodiments. As discussed herein, in some embodiments, in order for the site-specific user interaction tracking module 216 to activate the campaign 694 and for offers 696 to be displayed on the website 104, the site-specific user interaction tracking module 216 may have to determine that one or more activation criteria of the campaign 694 have been satisfied. A campaign 694 may include one or more offers 696, shown individually as offers 696a-c. An offer may have one or more rules 698, shown individually as rules 698a-c, associated with it. The offer 696a has no associated rules, as indicated by 698a. Since the offer 696a has no associated rules, the offer 696a is valid to show in the campaign 694. Offer 696b has the rule 698b associated with it. The rule 698b may have one or more associated conditions, and if the associated conditions are met, then the offer 696b will show in the campaign 694. Offer 696c has the rule 698c associated with it. The rule 698c may have one or more associated conditions, and if the associated conditions are not met, then the offer 696c will not show in the campaign 694. For example, as discussed with reference to FIG. 4F, if the checkbox 458 has been selected, then the offer 696c will not show in the campaign 694.

If no offers 696 can be shown in the campaign 694, because no offers are included in the campaign or because the conditions of the associated rules are not met, then the campaign 694 will not display any offers 696 even if the campaign 694 is activated.

As discussed with reference to, for example, FIG. 4F, an offer 696 may also be set to persist in the campaign 694 once the offer 696 has been displayed on the website 104, by selecting the checkbox 459 of FIG. 4F. If so, then once the conditions of the associated rule 698 have been met and the offer 696 has been shown, then the offer 696 will continue to be displayed on the website 104 to the user. For example, if an offer 696 has a rule 698 with conditions specifying that the offer 696 is to be displayed if the value of the products or services in a shopping cart of the user is between a first amount (for example, $50) and a second amount (for example, $100), then the offer 696 will continue to be shown to the user even if the value dips below the first amount or rises above the second amount. If the offer is not set to persist once shown, then the offer will not display if the value dips below the first amount or rises above the second amount.

As discussed with reference to, for example, FIG. 4D, an offer 696 may have a priority and/or be pinned. For example, an offer 696 may have a priority on a scale of 1-20, with 1 being the highest priority and 20 being the lowest priority. FIG. 6L is a block diagram 699 depicting priorities of offers in some embodiments. Offer 696d has a priority of one and is pinned but has no associated rules, as indicated by 698d. A pinned offer will rank above offers with rules if the pinned offer has a priority that is equal to or higher than the priorities of offers with rules. Accordingly, offer 696d will rank above offer 696e, which has a matching rule 698e, and offer 696f, which also has a matching rule 698f. Offers with associated rules whose conditions match will rank above offers with no associated rules even if they are lower priority. Accordingly, offer 696e and offer 696f will rank above offer 696g (which has no associated rule, as indicated by 698g), offer 696h (which has no associated rule, as indicated by 698h), and offer 696i (which has no associated rule, as indicated by 698i). Offers without rules, such as offer 696g, offer 696h, and offer 696i, will rank in order of priority. Accordingly offer 696g, which has a priority of 2, ranks above offer 696h, which has a priority of 3, and also above offer 696i, which has a priority of 4. The user interface module 218 uses the rank of offers to order the offers for display in the user interface element.

The offer and campaign management system 108 allows a user to utilize segments to target website users. A segment may be a grouping or collection of one or more website users based upon activities, actions, and/or attributes of the website users. For example, a segment may be defined as website users who have selected an item for purchase from the website 104 that is above the average item price of items on the website 104. As another example, a segment may be defined as website users who have selected an item for purchase from the website 104 but have not purchased the item in the previous seven days. The offer and campaign management system 108 may allow the user to create segments based on other activities, actions, and/or attributes of the website users. In some embodiments, the offer and campaign management system 108 provides a number of predefined segments for the user to utilize to target website users.

FIG. 7A depicts an example user interface 700 for displaying segments. The user interface 700 includes multiple columns for displaying attributes of segments, which include a name, a description, a build status, a created at timestamp, and an updated at timestamp. The columns further include a column 704 with user interface elements for editing, deleting, or duplicating a segment. The user interface 700 includes a list 701 of segments, user interface elements 702 for searching, filtering, and refreshing the list 701 of segments, and a create button 703.

FIG. 7B depicts an example user interface 710 for receiving segments in some embodiments. If the user selects the create button 703, the user interface module 218 displays the user interface 710. The user interface 710 allows a user to input a segment name in text field 712, a segment description in text field 714, a backload to date using the date and time selector 716 and one or more segment tags in the text field 718. The user interface 710 also allows the user to provide a segment type using the radio button 720. The segment types include an abandoned basket segment type, a clicked offer but did not go on to purchase segment type, a purchased anything in a given time period segment type, and a product match segment type. The user interface 710 also includes a button 728 that when selected returns the user to the user interface 700 of FIG. 7A and a button 726 for requesting creation of a segment.

If the user selects the abandoned basket segment type, the user interface module 218 displays user interface elements (not depicted in FIG. 7B) that allows the user to specify a grace period and a segment duration. If the user selects the clicked offer but did not go on to purchase segment type, the user interface module 218 displays user interface elements (not depicted in FIG. 7B) that allows the user to specify an offer, a grace period, and a segment duration. If the user selects the purchased anything in a given time period segment type, the user interface module 218 displays user interface elements (not depicted in FIG. 7B) that allows the user to specify a price threshold and a segment duration. If the user selects the product match segment type, the user interface module 218 displays a user interface element 722 that allows the user to add one or more new product criteria by selecting the plus icon 724. The user may add one or more product criteria related to brands, categories, SKUs, minimum price, maximum price, page view, and/or offer interactions.

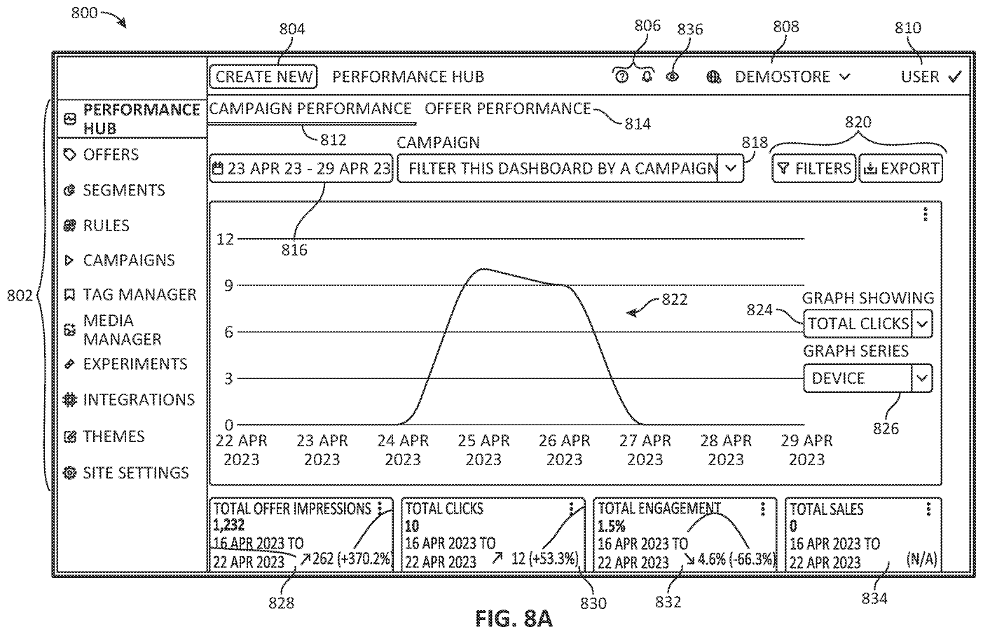

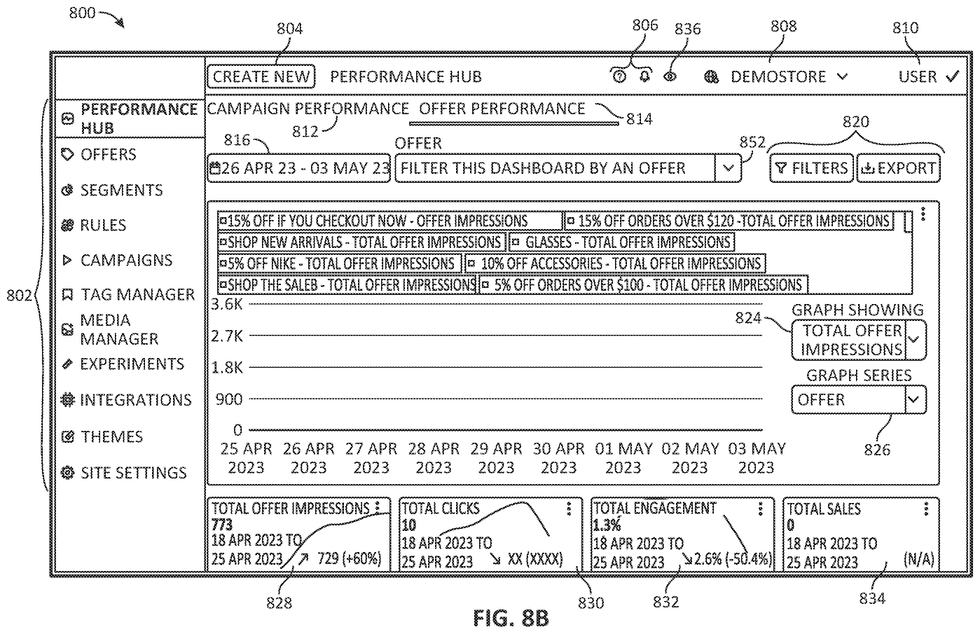

The reporting module 236 may generate and provide reports for display to users. For example, the reporting module 236 may generate and provide reports on the performance of campaigns and offers. FIGS. 8A and 8B depict an example user interface 800 for providing campaign performance reports and offer performance reports in some embodiments. The user interface 800 includes a navigation 802, a create new button 804, help and notification icons 806, a preview mode icon 836, a website selection drop-down 808, and a user account drop-down 810. The navigation 802 allows the user to navigate among different user interfaces of the offer and campaign management system 108. The create new button 804 allows the user to request the creation of a new campaign, a new offer, or a new rule. The help and notification icons 806 allow the user to view FAQs or help pages and to see notifications of the offer and campaign management system 108. The preview mode icon 836 allows the user to preview campaigns and offers without publishing the campaigns and offers. The website selection drop-down 808 allows the user to select a website to manage. The user account drop-down 810 allows the user to manage their account settings.

The user interface 800 may provide graphs for one or more campaigns or offers. The user may select to see performance of campaigns by selecting the campaign performance link 812 and may select to see performance of offers by selecting the offer performance link 814. The user may the graphs using the date and time selector 816 and may filter the graph by one or more campaigns by selecting the campaign drop-down 818 or the offer drop-down 852. The user interface 800 displays the graph 822. The user may select different data to display using a drop-down 824 and a drop-down 826. The user may filter or export the data using the buttons 820. The user interface 800 also includes additional graphs, such as a total offer impressions graph 828, a total clicks graph 830, total engagement graph 832, and a total sales graph 834. The user interface 800 may provide additional graphs not depicted in FIG. 8A, such as a conversion rate graph, a revenue graph, an average order value graph, and an average items for sale graph.

In some embodiments, the offer and campaign management system 108 may restrict or otherwise limit functionality depending upon privileges of the user. For example, certain links in the navigation 802 may only be available to users who have administrative privileges. As another example, the website selection drop-down 808 may only provide access to manage websites to users who have administrative privileges for those websites.

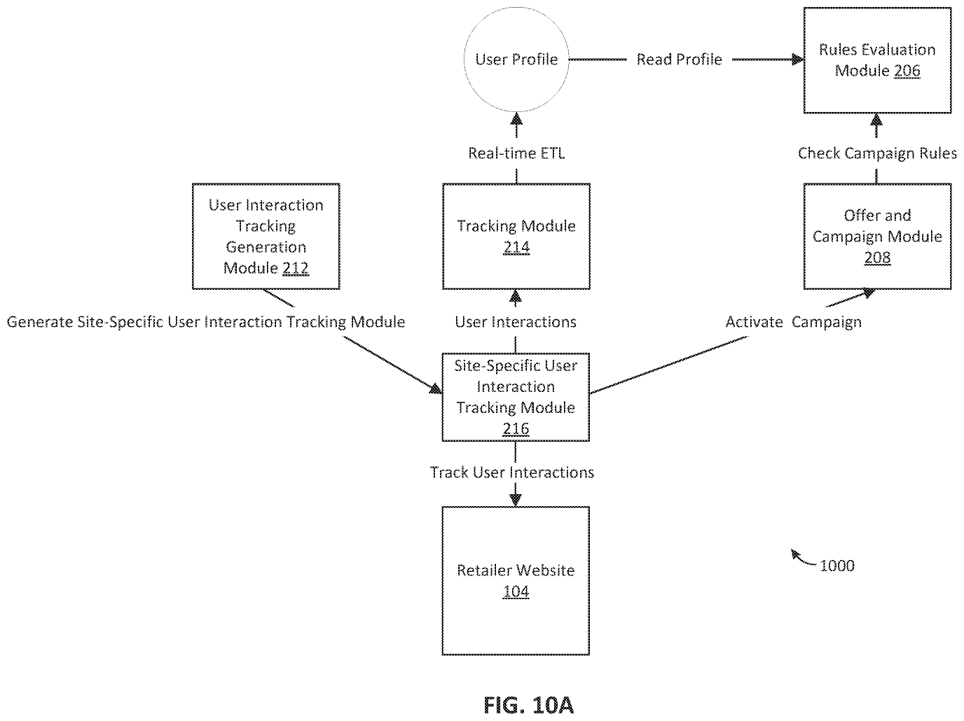

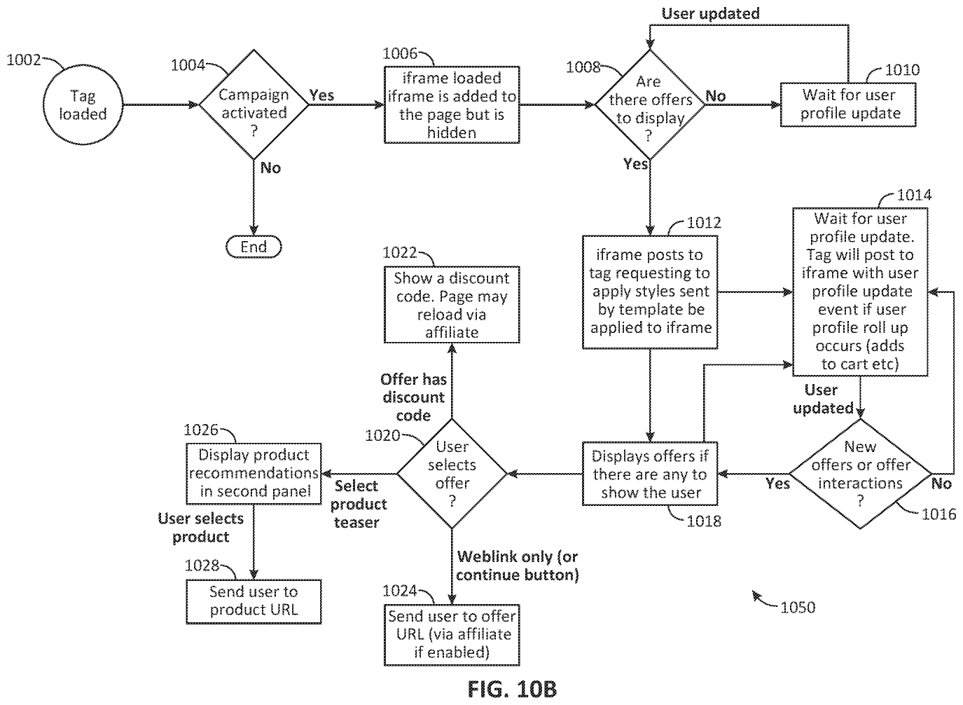

FIG. 10A is a block diagram 1000 depicting data flow between certain components of the offer and campaign management system 108 and a website 104 that provides multiple products or services for sale in some embodiments. The user interaction tracking generation module 212 may generate the site-specific user interaction tracking module 216 and provide it to the computing system 106 for installation on the website 104. In some embodiments, the site-specific user interaction tracking module 216 may be generated and provided by a third-party system (for example, a system of an affiliate network). In some embodiments, the site-specific user interaction tracking module 216 may be or include a tag. The tag may include code, such as client-side JavaScript code, that executes on a website user device 102. In such embodiments, the computing system 106 may utilize a tag manager to install the tag or install the tag via a tag of a third-party system (for example, a system of an affiliate network) that is already installed on the website 104. Each website 104 may have a site-specific user interaction tracking module 216 that has its own unique identifier, such as a universally unique identifier (UUID). The UUID may be the same as the UUID 911 depicted in FIG. 9A.

The site-specific user interaction tracking module 216 may detect or track interactions of users with the website 104 and send them to the tracking module 214. For example, the site-specific user interaction tracking module 216 may collect existing JavaScript variables (for example, data layers) and send them to the tracking module 214. The tracking module 214 may transform the user interactions data so that the user interactions data conforms to a common data schema for user profiles. For example, the tracking module 214 may create or update a user profile for a user accessing the website 104 that includes the user interactions with the website 104.

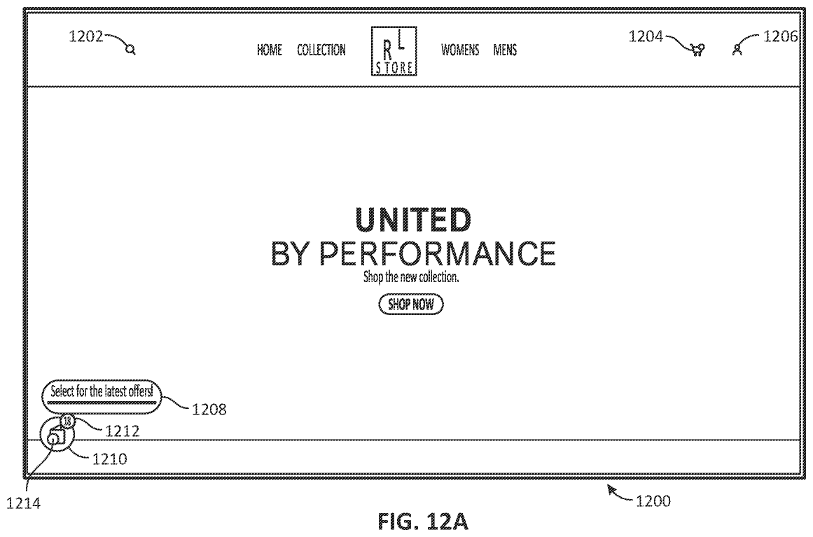

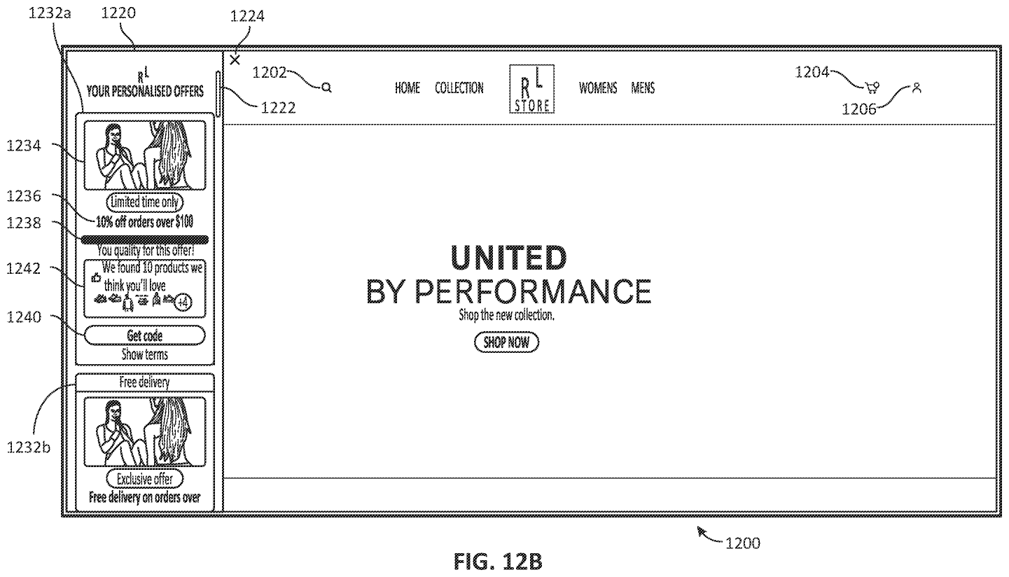

The site-specific user interaction tracking module 216 may provide the user interface elements for display for personalized offers and information. As discussed further herein, for example with reference to FIG. 10B, the site-specific user interaction tracking module 216 may detect interactions of the user with the website 104 and send them to the tracking module 214. The offer and campaign module 208 may determine that the user interactions satisfy one or more criteria for activating a campaign. The campaign may be linked with multiple offers for one or more products or services of the multiple products or services that the website 104 provides. If the offer and campaign module 208 determines that the user interactions satisfy the one or more criteria, the offer and campaign module 208 may activate the campaign. The site-specific user interaction tracking module 216 may detect further interactions of the user with the website 104 and send them to the tracking module 214. The tracking module 214 may update the user profile for the user to include the further user interactions. The rules module 206 may evaluate the multiple offers for the one or more products or services of the multiple products or services and the user profile to identify one or more particular offers of the multiple offers to display to the user. As discussed further herein, for example, with reference to FIGS. 12A-14B, the site-specific user interaction tracking module 216 may utilize a user interface element, such as panel, which may be or include an HTML inline frame (an HTML iframe), to display the one or more particular offers of the multiple offers. As the user continues to interact with the website 104, the site-specific user interaction tracking module 216 may detect the user interactions and send them to the tracking module 214. The user profile module 210 may update the user profile to include the user interactions. The rules module 206 may then evaluate the user profile and the multiple offers to identify offers to display to the user. If so, the site-specific user interaction tracking module 216 may send the offers to the user interface element for display.

As the user accesses products or services pages of the website 104, the site-specific user interaction tracking module 216 may obtain information regarding products or services. The information may include product or service names, product or service prices, product or service images, and product or service stock level. The site-specific user interaction tracking module 216 may send the information regarding the products or services to the tracking module 214 for storage in the products datastore 222. The product recommendation module 204 may then access the stored information regarding the products or services to generate product recommendations. In some embodiments, the offer and campaign management system 108 populates the products datastore 222 using information from a third-party product feed provider.

FIG. 10B is a flow diagram depicting a method 1050 for providing personalized offers and recommendations in some embodiments. The offer and campaign management system 108 may perform the method 1050. The method 1050 is described with respect to a wallet campaign type, but the method 1050 is applicable to the other campaign types described herein. The method 1050 begins at step 1002, where the website 104 loads the site-specific user interaction tracking module 216, which may be or include a tag as described herein. The site-specific user interaction tracking module 216 may detect a page access by the website user, an interaction with the website 104 by the website user, a user agent of the website user, and/or the website user being in a particular segment or group, collectively termed a first detection. Other types of first detections will be apparent.

At step 1004, the offer and campaign module 208 determines whether the first detection satisfies one or more activation criteria for activating a campaign. As discussed herein, a campaign may have a name, a description, a status, a visibility, which may be always visible or visible from a start date and time to an end date and time, and a theme. The theme determines the look and feel of offers and product recommendations provided to users and the look and feel of the user interface elements on the website 104 (for example, the visual indication of offers and the panel in which offers are displayed). The user may define the theme so that offers, and the user interface element in which offers are displayed, are consistent with a theme of the website 104. Having the theme of the user interface element, the offers and product recommendations, and the visual indication of offers consistent with the theme of the website 104 may be important to the entity operating the website 104. This is because the entity may wish website users to have a seamless and consistent experience in viewing products or services and viewing offers. Such a seamless and consistent experience may help to build trust and brand loyalty. The entity may also determine whether to provide product recommendations for the campaign. If so, then certain offer types, such as discount code offers, may include product recommendations, and offer types such as product recommendations offers may be displayed to users of the website 104.

The campaign may include multiple offers for the multiple products or services that the website 104 provides for sale. The offer and campaign module 208 may determine whether to provide the website user with one or more offers of multiple offers for one or more products or services of the multiple products or services that the website 104 provides for sale. If so, the method 1050 continues at step 1006, where the site-specific user interaction tracking module 216 causes the website 104 to load a user interface element in which the user interface module 218 may display personalized offers and information. The site-specific user interaction tracking module 216 may cause the user interface module 218 to initially hide the user interface element and to display a visual indication of offers. When a website user selects the visual indication of offers, the site-specific user interaction tracking module 216 may then cause the user interface module 218 to become visible and to display the user interface element in which offers are displayed. The site-specific user interaction tracking module 216 detects further interactions of the user with the website 104. For example, the site-specific user interaction tracking module 216 may detect that the user has interacted with the website 104 by viewing one or more products or services of the multiple products or services, selecting one or more products or services of the multiple products or services for purchase, or purchasing one or more products or services of the multiple products or services.

The user interactions may include attributes of the website user device 102, such as a location of the website user device 102 (for example, a city, country, a geofenced location, or a time zone). The user interactions may also include a day or time of the website user device 102 (for example, a day of the month, a day of the week, a time of day). The user interactions may also include a weather of a location of the website user device 102, attributes of the website user device 102, a determined propensity or predilection of the user to purchase products or services, and other attributes of the user or website user device 102 (for example, product engagement, user profile, user behavior, user segment or group). The user interactions may also be used to determine the amount of an offer. For example, a website user with a very low predilection score or a very high predilection score may be provided with a minimal or low offer, because the website user is either very unlikely to purchase or very likely to purchase. The offer and campaign management system 108 may provide a website user with an average predilection score with a good offer, because such a website user may or may not purchase a product or service, and thus it may be desirable to incentivize the website user to purchase a product or service by providing the website user with an attractive offer.

At step 1008, the offer and campaign module 208 determines whether there are offers to display to the website user. As discussed herein, the offer and campaign management system 108 may provide several types of offers, such as weblink offers, discount code offers, and product recommendation offers. FIGS. 11A-11C depict example visual representations of offers in some embodiments. FIG. 11A depicts an example visual representation 1100 for a weblink offer. The visual representation 1100 includes a video 1102, a label 1104, an offer title 1106, an offer subtitle 1108, and a button 1110 providing a call to action (“Shop Now”) for the user. In various embodiments, the visual representation 1100 may include one or more images, graphics, animations, and/or the like (e.g., as an addition to or as an alternative to the video 1102).

FIG. 11B depicts an example visual representation 1120 for a discount code offer. The visual representation 1120 includes an image 1122 of a product, a label 1124, an offer title 1126, an offer subtitle 1128, a countdown 1130, a progress bar 1132, a set of product recommendations 1134, a button 1136 to obtain the discount code, and a terms and conditions link 1138. As discussed further herein, for example, with reference to FIGS. 6A-6J, a discount code offer may have one or more rules associated with it that include conditions that have to be met in order for the user to obtain the discount code. The user interface module 218 may keep the button 1136 inactive until the conditions are met and activate the button 1136 after the conditions are met. For example, the discount offer shown in FIG. 11B has the condition that the user has to spend $60 to get 10% off their order and free shipping. The countdown 1130 may display a countdown timer indicating how much longer the discount code offer may be valid. The progress bar 1132, which may also be referred to as a progress visual indicator, may display the progress of the user in meeting the conditions. The countdown 1130 and the progress bar 1132 may, alone or together, encourage the user to select products or services for purchase in order to obtain the discount code, which may further incentivize the user to select for purchase products or services.

FIG. 11C depicts an example visual representation 1140 for a product recommendations offer. The visual representation 1140 includes an offer title 1142, an offer subtitle 1144, a group of recommended products 1146, and a button 1148 to view all recommended products. Each of the recommended products includes an image, a title, and a price. In some embodiments, the user may select a recommended product to view the page for the recommended product or add the selected product to a cart. As shown in FIG. 11B, a set of one or more product recommendations may also be included in a discount code offer. Although not shown in FIG. 11A, a link offer may similarly include a set of one or more product recommendations.

Returning to step 1008 of FIG. 10B, the offer and campaign module 208 evaluates the multiple offers and the user profile to identify one or more particular offers of the multiple offers to display to the user. The offer and campaign module 208 may identify one or more rules associated with the multiple offers. The one or more rules may each have one or more conditions. The offer and campaign module 208 may evaluate the one or more rules and the user profile to determine if the one or more conditions are met. For example, a rule may include the condition that a value of products or services the user has selected for purchase has to exceed a threshold amount. An offer that has that rule will show only if the rule conditions are met. As another example, a rule may include the conditions that the user is located in a specific geographic area and that a forecasted maximum temperature for the specific geographic area is not to exceed a threshold temperature. An offer that has that rule will only show if both rule conditions are met. An offer may not have any rules associated with it. As discussed with reference to, for example, FIGS. 4D and 4E, such an offer will be shown to the user if the campaign is activated.

If the offer and campaign module 208 determines that there are no offers to display, the method 1050 continues to step 1010, where the offer and campaign module 208 waits for an update to occur to the user profile. If the user profile module 210 updates the user profile, then the method returns to step 1008. If the offer and campaign module 208 determines that there are offers to display, then the method 1050 continues to step 1012. At step 1012, the user interface module 218 posts to the site-specific user interaction tracking module 216 requesting to apply styles sent by the user interface module 218 be applied to the user interface element. The styles may define the theme of the user interface element and the offers displayed within the user interface element. After step 1012, the method 1050 may continue to step 1014 or step 1018.

At step 1018, the user interface module 218 displays offers if there are any to show to the user. FIG. 12A depicts an example user interface 1200 displaying a visual indication 1210 of offers in some embodiments, with the user interface element that displays the offers initially hidden. The user interface 1200 includes a search icon 1202, a shopping cart icon 1204, and an account profile icon 1206 that allows the user to sign into the website 104. The visual indication 1210, which may also be referred to as a launcher, includes an icon 1214 of a wallet, a counter 1212 with a number of offers available to the user, and text 1208 indicating to the user that the user may select the visual indication 1210 to see the offers available to the user. Various aspects of the visual indication 1210 may be configurable, such as the icon 1214, colors, placement, and size. In some embodiments, the visual indication 1210 includes the text 1208 and not the icon 1214. In some embodiments, the visual indication 1210 includes both the text 1208 and the icon 1214. In some embodiments, the visual indication 1210 includes the icon 1214 and not the text 1208. The user may select the visual indication 1210, which causes the user interface module 218 to display the offers in a user interface element.

The offer and campaign management system 108 may provide personalized offers and information to users of the website 104 who are signed in and to users who are not signed in. For users who are not signed in, the offer and campaign management system 108 may utilize privacy-aware cookies or other techniques (for example, browser fingerprinting) to identify the users and provide the users with personalized offers and information. In this fashion the non-signed in users may see the same personalized offers and information across user sessions, even if such sessions are spaced far apart in time. For example, a user may see a personalized offer on the website 104, close their browser, return to the website 104 at a later time, and see the same personalized offer.

The user interface module 218 may display the visual indication 1210 anywhere on the user interface 1200. For example, the user interface module 218 may display the visual indication 1210 proximate to the shopping cart icon 1204 so that it is always visible to the user. The use of a wallet icon may provide several advantages. First, the wallet icon may convey to users that it is a hub for offers, marketing messages and contextual recommendations. Accordingly, the wallet icon may increase offer and/or message engagement and help users to trust the website and/or the entity operating the website more. Second, the site-specific user interaction tracking module 216 may dynamically update the wallet icon every time a new offer becomes available to the user by incrementing a counter of the wallet to indicate that there is a new offer available to the user. Accordingly, the wallet icon may increase the likelihood that the user may purchase products or services, thereby increasing the average order value (AOV) of the website.

FIG. 12B depicts the example user interface 1200 of FIG. 12A with a panel 1220 that displays offers in some embodiments. The user interface module 218 displays the panel 1220 after the user has selected the visual indication 1210 in the user interface 1200. The panel 1220 includes multiple offers, which appear as individual cards. If there are more offers for the user than can be shown in the panel 1220, the panel 1220 includes a scroll bar 1222 that allows the user to scroll through all the offers. The panel 1220 includes an offer 1232a and an offer 1232b. The offer 1232a, which is a discount code offer, includes an image 1234, a title 1236, a progress bar 1238, and a button 1240 labeled “Get Code.” The user may close the panel 1220 by selecting a close icon 1224 proximate to the panel 1220. If the user closes the panel 1220, the user interface module 218 may show the visual indication 1210 with the counter indicating the number of offers available to the user. For example, the user may wish to close the panel 1220 so that the user may view products or services, select products or services for purchase, or purchase products or services. The offer 1232a includes a set of product recommendations 1242.

Another advantage is that the visual indication 1210 provides a persistent and easily accessible hub for personalized offers and information. Even if the user closes the panel 1220 displaying the personalized offers and information, the offer and campaign management system 108 may continue to display the visual indication 1210 to the website user throughout the website user journey on the website 104. At any point during their browsing the website user may select the visual indication 1210 to see the offers and information available to the website user. Accordingly, the offer and campaign management system 108 may reduce any difficulty the website user has in finding and redeeming offers, which difficulty may occur if offers are only on landing pages and/or in navigation sections. The offer and campaign management system 108 may persist the personalized offers and information to the website user regardless of whether the website user is signed in or not and across visits by the website user to the website that are spaced apart in time. Such persistence of the personalized offers and information may help build loyalty of the website user to the website and/or the entity operating the website and increase the likelihood of the website user purchasing products or services from the website in the future.

Returning to the method 1050 of FIG. 10B, at step 1014, if a user profile update has occurred, the site-specific user interaction tracking module 216 sends additional offers or information to the panel (as depicted in FIGS. 7A and 7B, FIGS. 8A and 8B, and/or FIGS. 9A-9C). At step 1016, if there are no new offers or offer interactions, the method 1050 returns to step 1014. If there are new offers or offer interactions, the method continues to step 1018. After step 1018, the method may return to step 1014, or to step 1020. At step 1020, the site-specific user interaction tracking module 216 determines if the user selects an offer. If the offer is a discount code offer and the user selects it, the method continues to step 1022, where the user interface module 218 displays the discount code. If the offer is a weblink offer type, if the user selects it, the method 1050 continues at step 1024 where the user interface module 218 sends the user to the offer URL. If the offer is a product recommendations offer, or if it is another type of offer that includes product recommendations, and the user selects product recommendations, the method continues at step 1026, where the user interface module 218 displays product recommendations. If the user selects a product, the user interface module 218 sends the user to the product URL at step 1028.

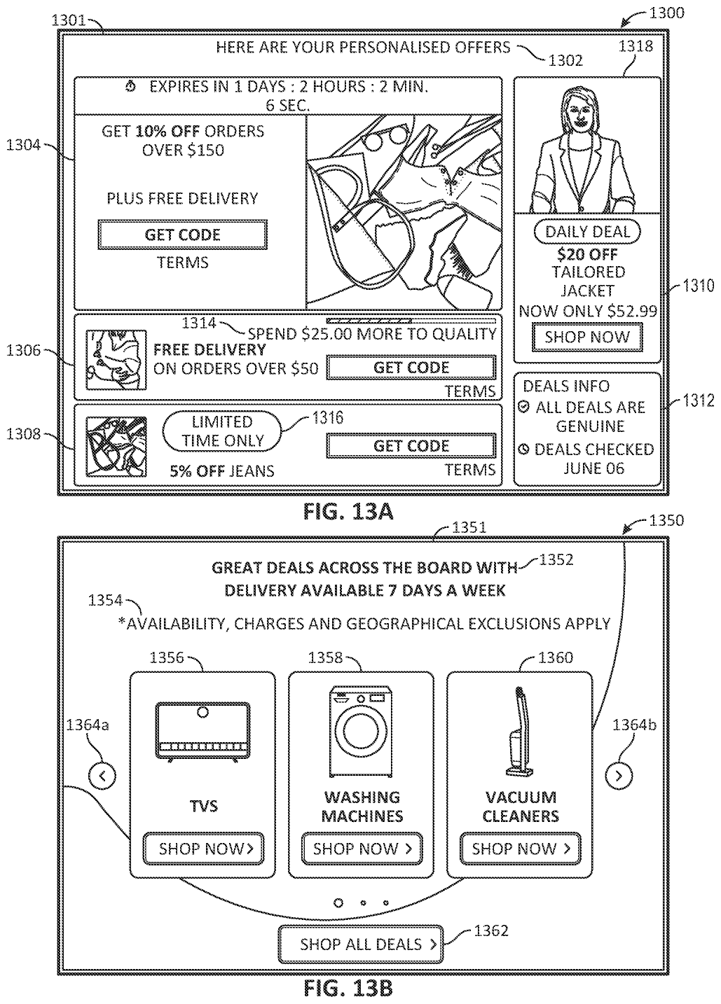

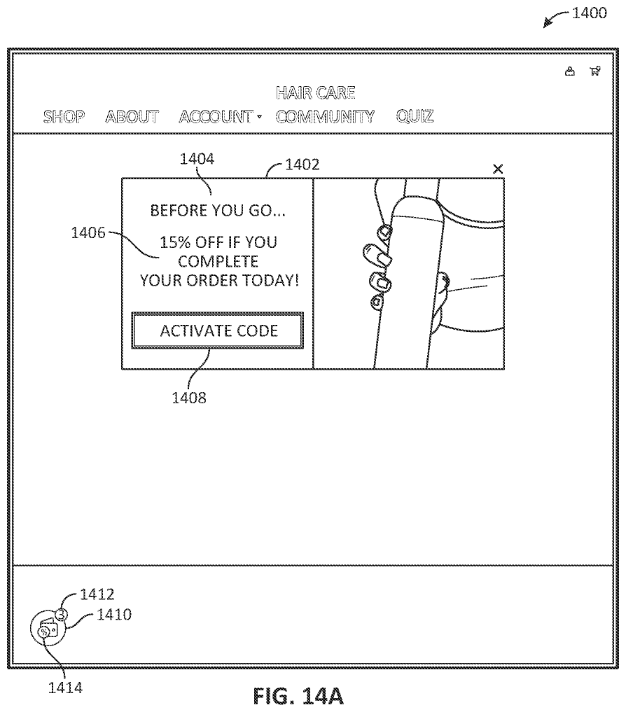

FIG. 13A depicts an example user interface 1300 for displaying offers in an offer group in some embodiments. A website 104 may provide the user interface 1300. The user interface 1300 includes an offer group 1301. The offer group 1301 has a title 1302 and includes multiple offers. A first offer 1304 may be featured and accordingly, is larger than other offers in the offer group 1301. The first offer 1304 is a discount code offer. A second offer 1306 is also a discount code offer and includes a progress bar 1314 showing a dollar amount of items that the user still has to purchase in order to qualify for the offer. A third offer 1308 includes a label 1316 and is a discount code offer. A fourth offer 1310 includes an image 1318 that is larger than the images in the second offer 1306 and the third offer 1308. The fourth offer 1310 is a weblink offer directing the user to a particular product that is discounted by a particular amount.

The offer group 1301 also includes a deals info section 1312 that notifies the user that all the deals are genuine and the last date the deals were checked. The offer and campaign management system 108 may provide the user interface 1300 for display on a website 104. This has the effect of incentivizing website users to access the website 104 to find discount codes or offers instead of searching for such discount codes or offers using search engines. Accordingly, the technology described herein may result in website users spending more time on websites 104 that use the offer and campaign management system 108 instead of other websites.

FIG. 13B depicts another example user interface 1350 for displaying offers in an offer group in some embodiments. A website 104 may provide the user interface 1350, or another website may provide the user interface 1350. The user interface 1350 includes an offer group 1351. The offer group 1351 has an offer title 1352 and an offer subtitle 1354. The offer group 1351 includes a first offer 1356, a second offer 1358, and a third offer 1360. Each of the first offer 1356, the second offer 1358, and the third offer 1360 is a weblink offer and includes a weblink to a different product categories. The offer group 1351 also includes a left navigation arrow 1364a and a right navigation arrow 1364b that allow the user to navigate to different offers in the offer group 1351. The offer group 1351 also includes a button 1362. If a website user selects the button 1362, the user interface module 218 may display a page listing all products for which there are offers.

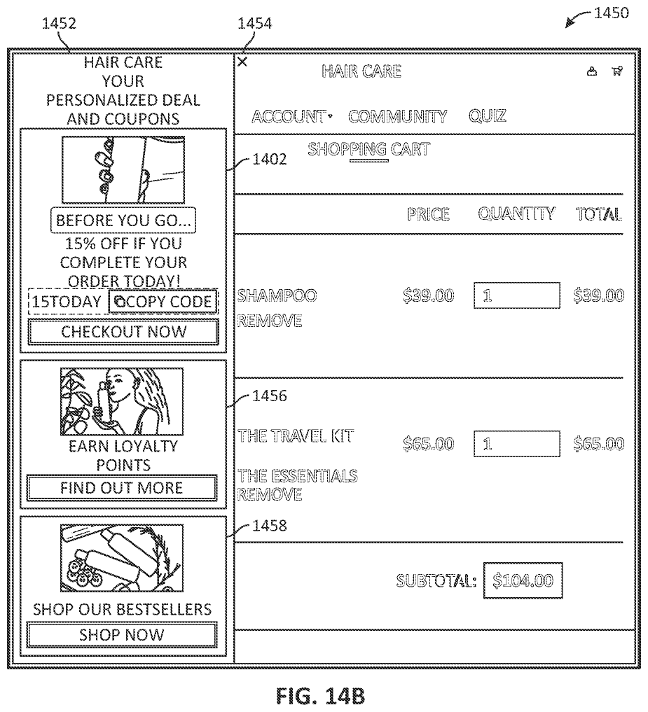

FIG. 14A depicts an example user interface 1400 displaying a visual representation of an offer in some embodiments. The user interface 1400 includes a visual representation 1402 of a discount code offer. The visual representation 1402 has a title 1404, a subtitle 1406, and a button 1408. The user interface module 218 displays the visual representation 1402 due to the site-specific user interaction tracking module 216 detecting a particular user interaction with the website 104 on which the user interface module 218 is displaying the user interface 1400. The campaign with which the discount code offer is linked is a pop-up campaign. The activation criterion of the pop-up campaign is an exit intent user interaction. The site-specific user interaction tracking module 216 has detected that the website user has either moved their mouse to the top of their browser or moved their mouse anywhere out of the browser. In response to such detection, the rules module 206 has evaluated the user profile against one or more rules and determined that the user interface module 218 should display the visual representation 1402. The user interface module 218 then displays the visual representation 1402.

The user interface 1400 also includes a visual indication 1410 of offers. The visual indication 1410 may be referred to as a widget and/or as a launcher. The visual indication 1410 includes an icon 1414 of a wallet and a counter 1412 with a number of offers available to the website user. In some embodiments, the visual indication 1410 includes text indicating to the website user that the website user may select the visual indication 1410 to see the offers available to the website user. The user interface module 218 has incremented the counter 1412 to account for the offer of the visual representation 1402. The website user may select the visual indication 1410 to view the offers available to the website user.

FIG. 14B depicts an example user interface 1450 in which the visual representation 1402 of the discount code offer of FIG. 14A is displayed in some embodiments. The user interface 1450 includes a user interface element 1452, such as a panel. The user interface module 218 displays the user interface element 1452 after or in response to the website user selecting the visual indication 1410. The user interface element 1452 includes visual representations of the three offers that the counter 1412 indicated: the visual representation 1402 of FIG. 14A, a second visual representation 1456 of an offer, and a third visual representation 1458 of an offer. The website user may close the user interface element 1452 by selecting a close icon 1454. The user interface module 218 closes the user interface element 1452 after or in response to the website user selecting the close icon 1454. The user interface module 218 may then display the visual indication 1410 of offers.

FIG. 15 depicts a block diagram of an example digital device 1500 according to some embodiments. The digital device 1500 is shown in the form of a general-purpose computing device. The digital device 1500 includes at least one processor 1502, RAM 1504, communication interface 1506, input/output device 1508, storage 1510, and a system bus 1512 that couples various system components including storage 1510 to the at least one processor 1502. A system, such as a computing system, may be or include one or more of the digital device 1500.

System bus 1512 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1500 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1502 is configured to execute executable instructions (for example, programs). In some embodiments, the at least one processor 1502 comprises circuitry or any processor capable of processing the executable instructions.

In some embodiments, RAM 1504 stores programs and/or data. In various embodiments, working data is stored within RAM 1504. The data within RAM 1504 may be cleared or ultimately transferred to storage 1510, such as prior to reset and/or powering down the digital device 1500.

In some embodiments, the digital device 1500 is coupled to a network, such as the communication network 110, via communication interface 1506. Still yet, the website 104, the computing system 106, and/or the offer and campaign management system 108 can communicate with one or more networks such as a local area network (LAN), a general wide area network (WAN), and/or a public network (for example, the Internet).

In some embodiments, input/output device 1508 is any device that inputs data (for example, mouse, keyboard, stylus, sensors, etc.) or outputs data (for example, speaker, display, virtual reality headset).

In some embodiments, storage 1510 can include computer system readable media in the form of non-volatile memory, such as read only memory (ROM), programmable read only memory (PROM), solid-state drives (SSD), flash memory, and/or cache memory. Storage 1510 may further include other removable/non-removable, volatile/non-volatile computer system storage media. By way of example only, storage 1510 can be provided for reading from and writing to a non-removable, non-volatile magnetic media. The storage 1510 may include a non-transitory computer-readable medium, or multiple non-transitory computer-readable media, which stores programs or applications for performing functions such as those described herein with reference to, for example, FIG. 2. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1512 by one or more data media interfaces. As will be further depicted and described below, storage 1510 may include at least one program product having a set (for example, at least one) of program modules that are configured to carry out the functions of embodiments of the invention. In some embodiments, RAM 1504 is found within storage 1510.

Programs/utilities, having a set (at least one) of program modules, such as the offer and campaign management system 108, may be stored in storage 1510 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the digital device 1500. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled”, “couplable”, “operably coupled”, “communicably coupled” and the like to other components. Such description or illustration should be understood as indicating that such components may cooperate or interact with each other, and may be in direct or indirect physical, electrical, or communicative contact with each other.

Components may be described or illustrated as “configured to”, “adapted to”, “operative to”, “configurable to”, “adaptable to”, “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services”, and “providing products and services.”

It may be apparent that various modifications may be made, and other embodiments may be used without departing from the broader scope of the discussion herein. For example, although a retailer may be described herein, aspects of the disclosure are applicable to any entity that provides products or services for purchase or lease, such as manufacturers, wholesalers, and distributors. As another example, while the offer and campaign management system 108 is described as providing offers, campaigns and rules for integration with websites, the offer and campaign management system 108 may provide offers, campaigns and rules for integration with applications executing on computing devices, such as apps executing on phones and/or mobile devices and/or native applications executing on laptop or desktop computers. As a further example, the user interface element in which personalized offers and product recommendations are displayed may be positioned proximate to the bottom side or the right side of a user interface. Therefore, these and other variations upon the example embodiments are intended to be covered by the disclosure herein.

1. A non-transitory computer-readable medium comprising executable instructions, the executable instructions being executable by one or more processors to perform a method, the method comprising:
providing an offer user interface of an offer and campaign management system, the offer user interface configured to allow a user to provide offer attributes for an offer, a visual representation of which may be displayed on a website that offers products for sale to users of the website, the offer attributes including an offer title, an offer discount code, and an offer tag, the offer and campaign management system of a first entity, the website of a second entity distinct from the first entity;
receiving, via the offer user interface, first offer attributes for a first offer, the first offer attributes including a first offer title, a first offer discount code, and a first offer tag;
generating the first offer based on the first offer attributes;
receiving, via the offer user interface, second offer attributes for a second offer, the second offer attributes including a second offer title, a second offer discount code, and the first offer tag;
generating the second offer based on the second offer attributes;
providing a campaign user interface of the offer and campaign management system, the campaign user interface configured to allow the user to provide campaign attributes for a campaign by which visual representations of offers may be displayed on the website, the campaign attributes including a campaign title, an offer tag for linking the campaign to one or more offers, and one or more campaign activation criteria for activating the campaign, the one or more campaign activation criteria for activating the campaign including at least one of page access criteria, user interaction criteria, and user agent criteria;
receiving, via the campaign user interface, first campaign attributes for a first campaign, the first campaign attributes including a first campaign title, the first offer tag, and one or more first campaign activation criteria for activating the first campaign;
generating the first campaign based on the first campaign attributes;
linking the first offer and the second offer with the first campaign based on the first offer tag;
detecting at least one of a first page access by a first user, first user interactions with the website by the first user, and a first user agent of the first user;
determining that at least one of the first page access by the first user, the first user interactions with the website by the first user, and the first user agent of the first user satisfy the one or more first campaign activation criteria for activating the first campaign;
activating the first campaign;
selecting the first offer or the second offer; and
displaying a first visual representation of the first offer including the first offer title and the first offer discount code or a second visual representation of the second offer including the second offer title and the second offer discount code on the website.

2. The non-transitory computer-readable medium of claim 1, the method further comprising:
providing a rule user interface of the offer and campaign management system, the rule user interface configured to allow the user to provide rule attributes for a rule which may be linked to one or more offers, the rule attributes including a rule name and one or more rule conditions;
receiving, via the rule user interface, first rule attributes for a first rule that may be applied to one or more offers, the first rule attributes including a first rule name and one or more first rule conditions;
generating the first rule based on the first rule attributes;
receiving a request to link the first offer with the first rule;
linking the first offer with the first rule;
receiving, via the rule user interface, second rule attributes for a second rule that may be applied to one or more offers, the second rule attributes including a second rule name and one or more second rule conditions;
generating the second rule based on the second rule attributes;
receiving a request to link the second offer and the second rule; and
linking the second offer and the second rule;
wherein selecting the first offer or the second offer includes selecting the first offer based on the one or more first rule conditions of the first rule or selecting the second offer based on the one or more second rule conditions of the second rule.

3. The non-transitory computer-readable medium of claim 2 wherein the one or more first rule conditions specify a first range of amounts of one or more products selected for purchase on the website and the one or more second rule conditions specify a second range of amounts of one or more products selected for purchase on the website, the second range of amounts of one or more products being greater than the first range of amounts of one or more products.

4. The non-transitory computer-readable medium of claim 3, the method further comprising detecting an amount of one or more products selected for purchase on the website by the first user, wherein selecting the first offer or the second offer includes selecting the first offer if the amount of one or more products selected for purchase on the website by the first user falls within the first range of amounts of one or more products and selecting the second offer if the amount of one or more products selected for purchase on the website by the first user falls within the second range of amounts of one or more products.

5. The non-transitory computer-readable medium of claim 2, the method further comprising:
detecting second user interactions with the website by the first user; and
updating a first user profile of the first user to include the second user interactions with the website by the first user;
wherein selecting the first offer or the second offer includes selecting the first offer based on the one or more first rule conditions of the first rule and the first user profile of the first user or selecting the second offer based on the one or more second rule conditions of the second rule and the first user profile of the first user.

6. The non-transitory computer-readable medium of claim 2, the method further comprising:
receiving a request to calculate an estimated reach of the first rule;
evaluating the first rule against user profiles of users who have accessed the website;
calculating the estimated reach of the first rule based on evaluating the first rule against the user profiles of the users who have accessed the website, and
displaying a visual indication of the estimated reach of the first rule.

7. The non-transitory computer-readable medium of claim 1, the method further comprising publishing the first campaign.

8. The non-transitory computer-readable medium of claim 7 wherein publishing the first campaign includes generating executable instructions for execution by computing devices of users who access the website, the executable instructions including the one or more first campaign activation criteria for activating the first campaign, and wherein:
detecting at least one of the first page access by the first user, the first user interactions with the website by the first user, and the first user agent of the first user includes detecting, using the executable instructions, at least one of the first page access by the first user, the first user interactions with the website by the first user, and the first user agent of the first user,
determining that at least one of the first page access by the first user, the first user interactions with the website by the first user, and the first user agent of the first user satisfy the one or more first campaign activation criteria for activating the first campaign includes determining, using the executable instructions, that at least one of the first page access by the first user, the first user interactions with the website by the first user, and the first user agent of the first user satisfy the one or more first campaign activation criteria for activating the first campaign, and
activating the first campaign includes activating, using the executable instructions, the first campaign.

9. The non-transitory computer-readable medium of claim 1 wherein the campaign user interface is further configured to allow the user to select a preview mode for a campaign, the method further comprising:
receiving a selection of the preview mode for the first campaign;
placing the first campaign in the preview mode; and
receiving a request to preview the first campaign,
wherein activating the first campaign includes activating the first campaign in response to receiving the request to preview the first campaign.

10. The non-transitory computer-readable medium of claim 1, the method further comprising:
receiving, via the offer user interface, third offer attributes for a third offer that may be displayed on the website, the third offer attributes including a third offer title, a third offer discount code, and a second offer tag, the second offer tag being different from the first offer tag;
generating the third offer based on the third offer attributes;
receiving, via the campaign user interface, second campaign attributes for a second campaign, the second campaign attributes including a second campaign title, the second offer tag, and one or more second campaign activation criteria for activating the second campaign;
generating the second campaign based on the second campaign attributes; and
linking the third offer with the second campaign based on the second offer tag.

11. A method comprising:
providing an offer user interface of an offer and campaign management system, the offer user interface configured to allow a user to provide offer attributes for an offer, a visual representation of which may be displayed on a website that offers products for sale to users of the website, the offer attributes including an offer title, an offer discount code, and an offer tag, the offer and campaign management system of a first entity, the website of a second entity distinct from the first entity;
receiving, via the offer user interface, first offer attributes for a first offer, the first offer attributes including a first offer title, a first offer discount code, and a first offer tag;
generating the first offer based on the first offer attributes;
receiving, via the offer user interface, second offer attributes for a second offer, the second offer attributes including a second offer title, a second offer discount code, and the first offer tag;
generating the second offer based on the second offer attributes;
providing a campaign user interface of the offer and campaign management system, the campaign user interface configured to allow the user to provide campaign attributes for a campaign by which visual representations of offers may be displayed on the website, the campaign attributes including a campaign title, an offer tag for linking the campaign to one or more offers, and one or more campaign activation criteria for activating the campaign, the one or more campaign activation criteria for activating the campaign including at least one of page access criteria, user interaction criteria, and user agent criteria;
receiving, via the campaign user interface, first campaign attributes for a first campaign, the first campaign attributes including a first campaign title, the first offer tag, and one or more first campaign activation criteria for activating the first campaign;
generating the first campaign based on the first campaign attributes;
linking the first offer and the second offer with the first campaign based on the first offer tag;
detecting at least one of a first page access by a first user, first user interactions with the website by the first user, and a first user agent of the first user;
determining that at least one of the first page access by the first user, the first user interactions with the website by the first user, and the first user agent of the first user satisfy the one or more first campaign activation criteria for activating the first campaign;
activating the first campaign;
selecting the first offer or the second offer; and
displaying a first visual representation of the first offer including the first offer title and the first offer discount code or a second visual representation of the second offer including the second offer title and the second offer discount code on the website.

12. The method of claim 11, further comprising:
providing a rule user interface of the offer and campaign management system, the rule user interface configured to allow the user to provide rule attributes for a rule which may be linked to one or more offers, the rule attributes including a rule name and one or more rule conditions;
receiving, via the rule user interface, first rule attributes for a first rule that may be applied to one or more offers, the first rule attributes including a first rule name and one or more first rule conditions;
generating the first rule based on the first rule attributes;
receiving a request to link the first offer with the first rule;
linking the first offer with the first rule;
receiving, via the rule user interface, second rule attributes for a second rule that may be applied to one or more offers, the second rule attributes including a second rule name and one or more second rule conditions;
generating the second rule based on the second rule attributes;
receiving a request to link the second offer and the second rule; and
linking the second offer and the second rule;
wherein selecting the first offer or the second offer includes selecting the first offer based on the one or more first rule conditions of the first rule or selecting the second offer based on the one or more second rule conditions of the second rule.

13. The method of claim 12 wherein the one or more first rule conditions specify a first range of amounts of one or more products selected for purchase on the website and the one or more second rule conditions specify a second range of amounts of one or more products selected for purchase on the website, the second range of amounts of one or more products being greater than the first range of amounts of one or more products.

14. The method of claim 13, further comprising detecting an amount of one or more products selected for purchase on the website by the first user, wherein selecting the first offer or the second offer includes selecting the first offer if the amount of one or more products selected for purchase on the website by the first user falls within the first range of amounts of one or more products and selecting the second offer if the amount of one or more products selected for purchase on the website by the first user falls within the second range of amounts of one or more products.

15. The method of claim 12, further comprising:
detecting second user interactions with the website by the first user; and
updating a first user profile of the first user to include the second user interactions with the website by the first user;
wherein selecting the first offer or the second offer includes selecting the first offer based on the one or more first rule conditions of the first rule and the first user profile of the first user or selecting the second offer based on the one or more second rule conditions of the second rule and the first user profile of the first user.

16. The method of claim 12, further comprising:
receiving a request to calculate an estimated reach of the first rule;
evaluating the first rule against user profiles of users who have accessed the website; and
calculating the estimated reach of the first rule based on evaluating the first rule against the user profiles of the users who have accessed the website.

17. The method of claim 11, further comprising publishing the first campaign.

18. The method of claim 17 wherein publishing the first campaign includes generating executable instructions for execution by computing devices of users who access the website, the executable instructions including the one or more first campaign activation criteria for activating the first campaign, and wherein:
detecting at least one of the first page access by the first user, the first user interactions with the website by the first user, and the first user agent of the first user includes detecting, using the executable instructions, at least one of the first page access by the first user, the first user interactions with the website by the first user, and the first user agent of the first user,
determining that at least one of the first page access by the first user, the first user interactions with the website by the first user, and the first user agent of the first user satisfy the one or more first campaign activation criteria for activating the first campaign includes determining, using the executable instructions, that at least one of the first page access by the first user, the first user interactions with the website by the first user, and the first user agent of the first user satisfy the one or more first campaign activation criteria for activating the first campaign, and
activating the first campaign includes activating, using the executable instructions, the first campaign.

19. The method of claim 11 wherein the campaign user interface is further configured to allow the user to select a preview mode for a campaign, and the method further comprises:
receiving a selection of the preview mode for the first campaign;
placing the first campaign in the preview mode; and
receiving a request to preview the first campaign,
wherein activating the first campaign includes activating the first campaign in response to receiving the request to preview the first campaign.

20. A system comprising at least one processor and memory containing executable instructions, the executable instructions being executable by the at least one processor to:
provide an offer user interface of an offer and campaign management system, the offer user interface configured to allow a user to provide offer attributes for an offer, a visual representation of which may be displayed on a website that offers products for sale to users of the website, the offer attributes including an offer title, an offer discount code, and an offer tag, the offer and campaign management system of a first entity, the website of a second entity distinct from the first entity;
receive, via the offer user interface, first offer attributes for a first offer, the first offer attributes including a first offer title, a first offer discount code, and a first offer tag;
generate the first offer based on the first offer attributes;
receive, via the offer user interface, second offer attributes for a second offer, the second offer attributes including a second offer title, a second offer discount code, and the first offer tag;
generate the second offer based on the second offer attributes;
provide a campaign user interface of the offer and campaign management system, the campaign user interface configured to allow the user to provide campaign attributes for a campaign by which visual representations of offers may be displayed on the website, the campaign attributes including a campaign title, an offer tag for linking the campaign to one or more offers, and one or more campaign activation criteria for activating the campaign, the one or more campaign activation criteria for activating the campaign including at least one of page access criteria, user interaction criteria, and user agent criteria;
receive, via the campaign user interface, first campaign attributes for a first campaign, the first campaign attributes including a first campaign title, the first offer tag, and one or more first campaign activation criteria for activating the first campaign;
generate the first campaign based on the first campaign attributes;
link the first offer and the second offer with the first campaign based on the first offer tag;
detect at least one of a first page access by a first user, first user interactions with the website by the first user, and a first user agent of the first user;
determine that at least one of the first page access by the first user, the first user interactions with the website by the first user, and the first user agent of the first user satisfy the one or more first campaign activation criteria for activating the first campaign;
activate the first campaign;
select the first offer or the second offer; and
display a first visual representation of the first offer including the first offer title and the first offer discount code or a second visual representation of the second offer including the second offer title and the second offer discount code on the website.
